(19) United States
(12) Patent Application Publication
(10) Pub. No.: US 2002/0033964 A1
(43) Pub. Date: Mar. 21, 2002

(54) Image administering system

(75) Inventors: Takanobu Suzuki, Kawasaki-shi (JP); Kanji Itaki, Yokohama-shi (JP); Masahiro Machida, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 09/953,360

(22) Filed: Sep. 17, 2001

(30) Foreign Application Priority Data
Sep. 19, 2000 (JP) 2000-284304
Jun. 29, 2001 (JP) 2001-199745
Sep. 19, 2000 (JP) 2000-284306
Jun. 29, 2001 (JP) 2001-199746

(51) Int. Cl. B41J 1/00; G06F 15/00

(52) U.S. Cl. 358/1.15

(57) ABSTRACT

An image administrating apparatus and a distributed processing system capable of distributing and processing a copy job efficiently. Also, an administration apparatus, an electronic filing method, a recording medium and an electronic filing system capable of efficient printing. At a head office, a system is instructed to read an image, which is to be outputted to a printer at a branch office, by a scanner and to transfer the image to the branch office. At a predetermined time, a file system transfers a resulting transfer job to a file system at the branch office. Elsewhere, a client can designate user information for a reprinting file and options information over the Internet, and upload them to a server. This server stores the data in a database and transmits a registration ID to the client. The client can reprint by transmitting the registration ID to the server.

### BACKGROUND OF THE PRESENT INVENTION

1. Field of the Present Invention

The present invention relates to an image administering apparatus, a distributed processing system, an administration apparatus, an electronic filing method, a recording medium, a distributed processing system and an electronic filing system. More particularly, the present invention relates to a distributed processing system and an image administering system in which a plurality of image outputting systems having a scanner for reading an image of a document, a plurality of printers, a printer server and a file system are distributed and arranged and are connected through a network; and to an administration apparatus, an electronic filing method, a recording medium and an electronic filing system to be applied to a system which is provided with a printer, a printer server and a client computer connected to the network.

2. Description of the Related Art

In recent years, network technology has developed, and it is commonplace in offices for a system to be enabled to output images from individual printers by connecting scanners, computers and printers to a network.

In this system, for example, an image read by a scanner is usually outputted from one of the printers in the office. In recent years, however, there has been proposed a distributed processing system in which the input and the output are separated such that the image is not processed in the office but a copy job of document data read by a scanner at a head office is transferred through the network to a branch office and printed at the branch office.

However, the aforementioned distributed processing system is accompanied by a problem that, if the copy job of the document data read by the scanner of the head office is immediately transferred to the branch office, transfer duration may be prolonged depending upon loading on the network, or the network may be unnecessarily heavily loaded by the transfer.

In the copy servicing field, on the other hand, there has been proposed a distributed processing system in which each copy job ordered at a satellite shop is distributed and processed at a production center or at the satellite shop. In this case, there is a problem how efficiently the copy job can be distributed and processed.

It is also usual to construct not only a system such that an image can be outputted, by connecting scanners, computers and printers through a network, but also such that each individual apparatus can be shared, by connecting the scanners, the computers, the printers and copying machines to the network.

When the image read by the scanner, or a document file generated by a computer or the like, is to be copied in such a system, it is usual that the read image is outputted once from the printer and that this outputted document is copied to a desired number at the copying machine.

In the prior art, however, if the same document is to be copied again later, the already copied document has to be printed again before being copied, which causes a problem that work efficiency is deteriorated.

### SUMMARY OF THE PRESENT INVENTION

An object of the present invention is to provide an image administering apparatus and a distributed processing system, which can distribute and perform a job such as a copy job efficiently.

Another object of the present invention is to provide an administration apparatus, an electronic filing method, a recording medium and an electronic filing system capable of performing a printing operation efficiently.

In order to achieve the above-specified objects of the present invention, there is provided an image administrating apparatus including: an image inputting device connected to a network; a plurality of image output devices connected to the network and having different processing capacities from one another; and a controller that performs comparison of a processing amount of a printing job of image data inputted by the image inputting device with a predetermined processing amount, selects at least one of the image output devices in accordance with a result of the comparison, and transmits the printing job through the network to the at least one of the image output devices.

According to the present invention, the controller compares the processing amount of the printing job of the image data inputted from the image inputting device connected to the network with a predetermined threshold value (i.e., a predetermined processing amount). The processing amount of the printing job is determined by, for example, the size of the image data and the print number. Further, the controller selects one or more of a plurality of image outputting devices, which have different processing capacities, on the basis of the comparison result between the processing amount of the printing job and the predetermined threshold value and transmits the printing job through the network; that is, to the image outputting device best suited for processing the printing job according to the processing amount of the printing job. Therefore, the printing job can be efficiently processed.

The controller may transmit the printing job at a preset time period (for example, time of day). For example, the printing job can be efficiently processed by transmitting it at a time period such as nighttime, when the load on the network is expected to be light.

On the other hand, the controller may change the transmission timing of the printing job in accordance with the loading condition of the network. The load condition (communication condition) of the network is monitored. If it is decided that the load (communication amount) on the network exceeds a predetermined threshold value, the transmission of the printing job may not be performed quickly. Therefore, the transmission is delayed until the load on the network becomes lower than the threshold value, and is started when the load is below the threshold value. Thus, the printing job can be efficiently processed.

Moreover, the controller may, if the processing amount of the printing job exceeds the predetermined processing amount, divide the printing job into separate jobs having processing amounts that do not exceed the predetermined amount, and may transmit the separate jobs to two or more of the image output devices. By thus distributively executing the processing of the printing job among the image outputting devices, the printing job can be efficiently processed.

According to the present invention, there is also provided a distributed processing system including: a first system including an output device connected to a network and capable of outputting an image on the basis of information on image data and on image data output form, and a first administration device connected to the network which transmits the information, which is acquired through the network, to the output device; and a second system connected with the first system through the network and including an image inputting device which includes an image input device for inputting image data, an information input device for inputting a transmission time at which the information is to be transmitted, and a transmitter connected to the network for transmitting the image data inputted from the image input device and the information, which is inputted from the information input device, through the network, and a second administration device connected to the network which holds the information which is transmitted from the image inputting device and, at the transmission time, transmits the information through the network to the first administration device.

According to this invention, the first system includes the image outputting device and the first administration device. The image outputting device is connected to the network, such as a LAN, and outputs the image on the basis of the information on the image data and the image data output form, as transmitted through the network. For example, the information on the image data output form may include paper size and a number of prints. The image outputting device is, for example, a network printer which can be connected to the network, so that the image based on the image data transmitted through the network is printed on the recording paper in the paper size and the output number, as designated by the information on the image data output form. The image referred to herein may be a document image formed of only letters, an image containing letters, a photograph and/or a picture, or the like.

The first administration device is connected to the network and transmits the information on the image data and the image data output form, as transmitted from the network, to the image outputting device. That is, the administration device functions as a so-called “server”, administering the image data transmitted through the network and outputting the data to the image outputting device.

The second system is connected with the first system through the network and includes the image inputting device and the second administration device. The image inputting device includes the image input device, the information input device and the transmitter.

The image input device inputs the image data. For example, a scanner or a facsimile for reading a document by using a reading sensor such as a CCD, or a computer for reading image data stored in an external storage device can be used as the image input device.

The information input device inputs the information on the image data output form and the transfer time at which the information on the image data and the image data output form are to be transferred. For example, a menu for designating the information on the image data output form and the transfer time can be displayed on a display panel such as a touch panel or a display, so that designation can be performed by hand, a keyboard or a mouse. Here, the transfer time can be designated by year, month and day, by hour, minute and second, in terms of time of day, or by predetermined time periods such as daytime, nighttime and the like.

The transmitter is connected to the network, and transmits the image data inputted from the image input device and the information inputted from the information input device through the network.

The second administration device is connected to the network, and holds the information on the image data output form inputted from the information input device and the image data transmitted from the image inputting device. At the transfer time inputted from the information input device, the second administration device transfers the information on the held image data and the image data output form through the network to the first administration device.

Thus, the image inputted at the first system can be transferred at the designated transfer time to the second system. By setting the transfer time to a time period when there is a light load on the network, such as at night, the printing routine can be efficiently executed without unnecessarily increasing the load on the network.

According to the present invention, there is further provided a distributed processing system including: a first system including a first image outputting device connected to a network and capable of outputting an image on the basis of information on image data and on image data output form, and a first administration device connected to the network and capable of transmitting the information on image data and image data output form, which is acquired from the network, to the first image outputting device; and a second system connected with the first system through the network and including a second image outputting device having processing capacity different from processing capacity of the first image outputting device, connected to the network, and capable of outputting an image on the basis of the information, an image inputting device which includes an image input device for inputting image data, an information input device for inputting information on the image data output form, and a transmitter connected to the network for transmitting the image data inputted from the image input device and the information on the image data output form inputted from the information input device through the network, and a second administration device connected to the network, which, in accordance with a processing amount based on the information on image data and image data output form transmitted from the image inputting device, transmits the information on image data and image data output form through the network to at least one of the first administration device and the second image outputting device.

According to this invention, the first system includes the first image outputting device and the first administration device as described above.

The second system includes the second image outputting device, the image inputting device and the second administration device. The second image outputting device has a different processing capacity from the first image outputting device, such as speed of printing or size of processable images.

The image inputting device includes the image input device, the information input device and the transmitter. In accordance with the processing amount based on the information on the image data transmitted from the image inputting device, and in accordance with the image data output form, that is, the print number or the size of the image data, the second administration device transmits the information on the image data and the image data output form through the network to at least one of the first administration device and the second image outputting device.

If the first image outputting device has a higher processing capacity than that of the second image outputting device and the print number of the image inputted from the image inputting device to be processed exceeds a predetermined number, then the information on the image data and the image data output form is transmitted to the first administration device of the first system, which has having the first image outputting device with the higher processing capacity. As a result, the information on the image data and the image data output form is transmitted from the first administration device to the first image outputting device, and the image is outputted. On the other hand, if the print number is lower than the predetermined value, the information on the image data and the image data output form are transmitted to the second image outputting device, and the image is outputted there.

When the print number exceeds the predetermined value, the information on the image data and the image data output form may also be transmitted to the second image outputting device so that excess prints can be outputted by the second image outputting device. In other words, the processing may be distributedly executed.

Thus, in accordance with the processing amount based on the information on the image data and the image data output form, one of the first image outputting device and the second image outputting device, with different processing capacities, can be selected to execute the processing or both of them may distributedly execute the processing, so the printing routine can be executed efficiently.

According to the present invention, there is furthermore provided an administration apparatus connected through a network to a first client, a second client and an output device, the apparatus including: a first generator which generates filing screen data and outputs the generated filing screen data to the first client, for display of a filing screen at the first client, to enable filing of document information relating to a document; a second generator which generates administration screen data and outputs the generated administration screen data to the second client, for display of an administration screen at the second client, to enable administration of the document information; and a controller which receives through the network the document information, which is filed at the filing screen displayed at the first client, outputs the document information to the administration screen displayed at the second client, and, on the basis of input information which is inputted at the administration screen, outputs the document information to the output device.

According to the present invention, the filing image data generated by the first generator is outputted through the network to the first client. As a result, the filing screen is displayed in the first client so that the document information relating to the document can be filed on the first client side. This first client transmits the filed document information through the network.

The administration screen data generated by the second generator is outputted through the network to the second client. As a result, the administration screen for administrating the document information is displayed in the second client and the document information can be controlled at the second client side.

The controller receives the document information, as inputted on the basis of the filing screen displayed in the first client, through the network. Then, the controller displays the received document information on the administration screen displayed at the second client. As a result, it can be ascertained on the second client side that the document has been filed from the first client. When the information on the document to be outputted has been inputted to the displayed administration screen, the second client transmits that information through the network as input information. In response to this input information, the controller controls the output device connected to the network to output the document.

Thus, the document information can be filed (stored) in the administration device from the first client such that the document can be outputted again at any later time, which improves working efficiency.

According to the present invention, there is still further provided an electronic filing method including the steps of: generating filing screen data and outputting the generated filing screen data to a first client, for displaying a filing screen at the first client, to enable filing of document information relating to a document; generating administration screen data and outputting the generated administration screen data to a second client, for displaying an administration screen at the second client, to enable administration of the document information; receiving through the network the document information filed at the filing screen displayed at the first client and displaying the received document information at the administration screen displayed at the second client; and on the basis of input information which is inputted to the administration screen, outputting the document to an output device connected to the network. As a result, the document information can be filed from the first client such that the document can be outputted again at any later time, which improves work efficiency.

According to the present invention, there is even further provided a computer-readable recording medium recorded with an electronic filing program for causing a computer for administering the electronic filing to execute: generating filing screen data and outputting the generated filing screen data to a first client, for displaying a filing screen at the first client, to enable filing of document information relating to a document; generating administration screen data and outputting the generated administration screen data to a second client, for displaying an administration screen at the second client, to enable administration of the document information; receiving through the network the document information filed at the filing screen displayed at the first client and displaying the received document information at the administration screen displayed at the second client; and on the basis of input information which is inputted to the administration screen, outputting the document to an output device connected to the network. The process described above can be executed by reading the program recorded in the recording medium.

According to the present invention, there is yet moreover provided an electronic filing system including: a document data storage connected to a network, which stores document data; an output device connected to the network and capable of outputting a document on the basis of information on document data and document options; a control device including a display input device which displays a control screen generated on the basis of signals for generating the control screen, for input to the displayed control screen of control information including user information, information for designating the document data, and information on the document options, and a transmitter connected to the network, which transmits the control information through the network and acquires the signals for generating the control screen through the network; an administration control device including an administration display input device which displays an administration control screen generated on the basis of signals for generating the administration control screen, for input of information for designating the control information inputted to the display input device, which information for designating the control information is stored at the document data storage, and for input of information for designating the output device to output the document data, and an administration transmitter connected to the network, which acquires the signals for generating the administrating control screen through the network; and an administration device including a communication unit connected to the network, which fetches the document data that is designated by the information for designating the document data, which information is transmitted from the control screen, generates the signals for generating the control screen and transmits the signals to the control device, generates the signals for generating the administration control screen and transmits the signals to the administration control device, and transmits the information on document data and document options of the designated document data through the network to the designated output device, and a storage which stores the fetched document data, and stores the user information and the information on the document options which are transmitted from the control device.

According to the present invention, the document data storage is connected to the network, such as a LAN, to store the document data. The document data contains image data read by a scanner or the like, or a document file generated by a personal computer or the like.

The output device is connected to the network, and outputs the document on the basis of the information on the document data transmitted through the network and the document options. The information on the document options includes, for example, a number of documents, a print number, size, paper type, etc. The output device is, for example, a network printer which can be connected to the network, so that the document data transmitted through the network can be printed in the document number and print number on the paper type designated by the information on the document options. The output device may also be a writing device for recording the document data in a recording medium, such as a CD-ROM.

The control device includes the display input device and the transmitter. The display input device displays the control screen which was generated on the basis of the signals for generating it. Moreover, from this displayed control screen, there can be inputted the user information, the information for designating the document data, and the information on the document options. The user information contains, for example, information on the name of the user, contact details and request details.

The transmitter is connected to the network, and transmits through the network information inputted from the display input device, such as the user information, the information for designating the document data and the information on the document options. Also, the transmitter receives the signals for generating the control screen through the network. The display input device generates and displays the control screen from the signals.

The administration control device includes the display input device and the administration transmitter. The administration display input device displays the administration control screen which is generated on the basis of the signals for generating that screen. Moreover, at this administration control screen, there can be inputted the information for designating the user information, the information on the document data and the document options, and the information for designating the document outputting output device, as stored in the storage.

The administration transmitter is connected to the network, and transmits the information inputted from the administration display input device (that is, the information for designating the user information, the information on the document data and the document options, and the information for designating the document outputting output device, as stored in the storage) through the network. Also, the administration transmitter receives the signals for generating the administration control screen through the network.

The administration device includes the transceiver and the storage. The transceiver is connected to the network, and fetches the document data designated by the information for designating the document data, which is transmitted from the control device. Further, the transceiver generates and transmits the signals for generating the control screen to the control device, and generates and transmits the signals for generating the administrating control screen to the administration control device. The signals for generating the control screen and the signals for generating the administration control screen can be provided, for example, in an HTML (Hyper Text Markup Language) file. Specifically, by causing the administration device to function as a WWW (world wide web) server and the control device and the administration control device to function as a WWW client, the control screen and the administration control screen can be made into Web pages. Also, the transceiver transmits the information on the document data and the document finish, as designated, through the network to the designated output device.

The storage stores the fetched document data, the user information and the information on the document options, as transmitted from the control device.

Thus, the user information and the information on document data and document options can be filed (stored) from the control device into the administration device so that they can be used for output again at any later time.

The administration device of the present invention transmits a registration ID to the control device when it receives the user information, the information for designating the document data and the information on the document options, which are transmitted from the control device, and stores the user information, the information for designating the document data and the information on the document options in the storage in correspondence with the registration ID.

According to the present invention, the administration device of the present invention, when it receives the user information, the information for designating the document data and the information on the document options, generates an ID unique to the received information, and transmits the registration ID to the control device. In correspondence with the registration ID, the administration device stores the user information, the information for designating the document data and the information on the document options in the storage. Consequently, when a user requests re-output, the user may simply transmit the registration ID and the user can perform the outputting routine efficiently without inputting the various information again.

### BRIEF DESCRIPTION OF THE DRAWINGS

FIG. 1 is a schematic structural diagram of a print system relating to the present invention.

FIG. 2 is a schematic structural diagram of a scanner relating to the present invention.

FIG. 3 is a schematic structural diagram of a printer relating to the present invention.

FIG. 4 is a schematic structural diagram of a server relating to the present invention.

FIG. 5 is a flow chart of a control routine to be executed at the printer.

FIG. 6A and FIG. 6B are flow charts of a control routine to be executed at the server.

FIG. 7A and FIG. 7B are flow charts of a control routine to be executed at the scanner.

FIG. 8 is a diagram showing one example of the structure of a system in which a print system of a head office and a print system of a branch office are connected.

FIG. 9 is a flow chart of a control routine to be executed by a server on the branch office side.

FIG. 10 is a diagram showing one example of a system in which a print system of a production center and a print system of a satellite shop are connected.

FIG. 11A and FIG. 11B are flow charts of a control routine to be executed by a server on the satellite shop side.

FIG. 12 is a schematic structural diagram of a client relating to the present invention.

FIG. 13 is a conceptual diagram for explaining the concept of an electronic filing system.

FIG. 14A and FIG. 14B are flow charts of a control routine to be executed at a server.

FIG. 15A and FIG. 15B are flowcharts of a control routine to be executed at a client on a user side.

FIG. 16A and FIG. 16B are flow charts of a control routine to be executed at a server.

FIG. 17A and FIG. 17B are flow charts of a control routine to be executed at a client on an operator side.

FIG. 18A and FIG. 18B are flow charts of a processing routine for a detail request.

FIG. 19 is a flow chart of a processing routine for contact details setting.

FIG. 20 is a flow chart of a processing routine for setting request items.

FIG. 21 is a diagram for explaining an electronically inputted file.

FIG. 22 is a diagram showing an example of a customer information inputting screen.

FIG. 23 is a diagram showing an example of an options information inputting screen.

FIG. 24 is a diagram showing an example of an options information inputting screen.

FIG. 25 is a diagram showing an example of a file information inputting screen.

FIG. 26 is a diagram showing an example of a file information inputting screen.

FIG. 27 is a diagram showing an example of a registration completion screen.

FIG. 28 is a diagram showing an example of a requested content listing screen.

FIG. 29 is a diagram showing an example of a detail requesting screen.

FIG. 30 is a diagram showing an example of a setting changing screen.

FIG. 31 is a diagram showing an example of a setting changing screen.

FIG. 32 is a diagram showing an example of a contact details setting screen.

FIG. 33 is a diagram showing an example of a contact details confirmation screen.

FIG. 34 is a diagram showing an example of a request item settings screen.

FIG. 35 is a diagram showing an example of another request item settings screen.

FIG. 36 is a diagram showing an example of a further request item settings screen.

FIG. 37 is a diagram showing an example of a different request item settings screen.

FIG. 38 is a diagram showing an example of yet another request item settings screen.

FIG. 39 is a diagram showing an example of a yet further request item settings screen, and

FIG. 40 is a diagram showing an example of still another request item settings screen.

### DESCRIPTION OF THE PREFERRED EMBODIMENTS

### First Embodiment

A first embodiment of the present invention will be described in detail with reference to the accompanying drawings. First of all, a basic structure of a print system to be used in this embodiment will be described.

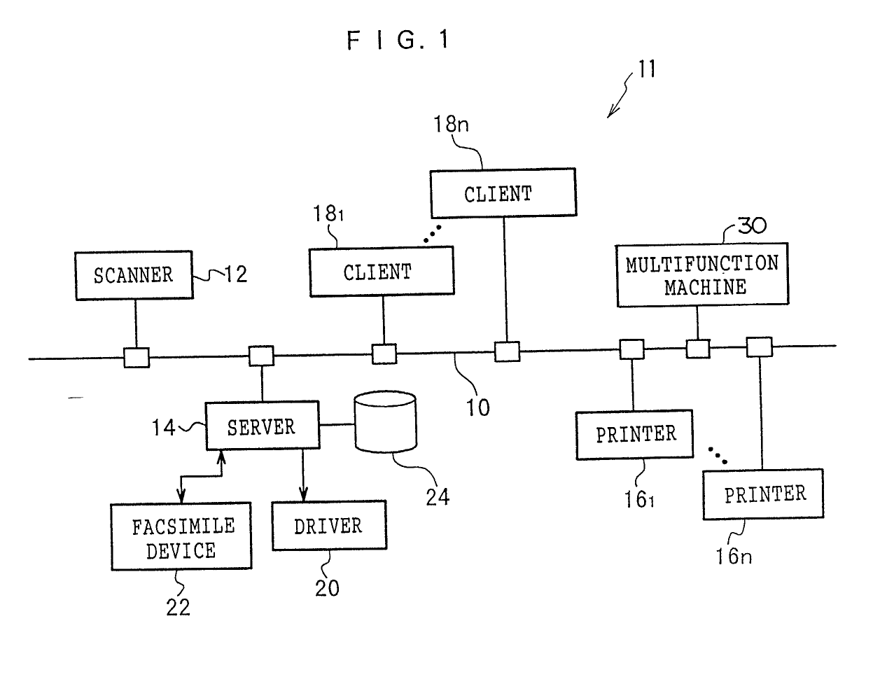

As shown in FIG. 1, a print system 11 of this embodiment is constructed by connecting a scanner 12 or image data input unit for inputting image data, a server 14, printers 16₁, 16₂, and so on to 16ₙ or a plurality of image output units, and a plurality of clients 18₁, 18₂, and so on to 18n, to a network 10 structured by an internet or a LAN. These image data are, for example, expressed as TIFF files (Tagged Image File Format). With the network 10, there may be connected a multifunction machine 30 which has a printer function, a scanner function and a facsimile function.

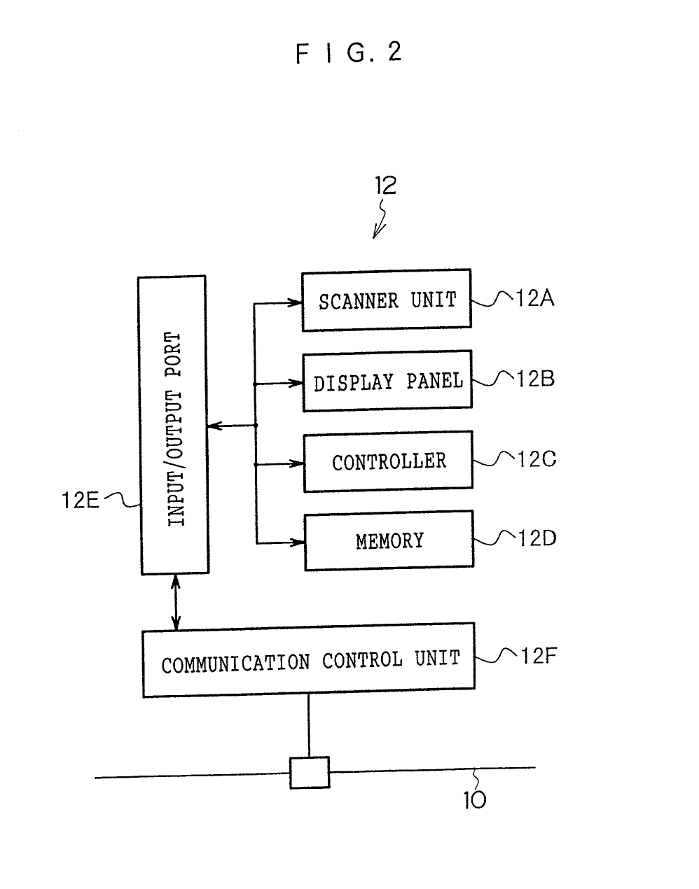

The scanner 12 is provided, as shown in FIG. 2, with: a scanner unit 12A having a CCD for reading an image recorded on a document; a display panel 12B such as a touch panel which functions as a user interface for displaying a print control screen having a plurality of icons and is for inputting data of printing format (or output formats) of a printer by touching one of the icons displayed; a controller 12C for controlling the scanner as a whole; a memory 12D for storing the image data or the like read by the scanner unit 12A; and an input/output port 12E for inputting/outputting data. These scanner unit 12A, display panel 12B, controller 12C, memory 12D and input/output port 12E are mutually connected through a bus. The input/output port 12E is connected to the network 10 through a communication control unit 12F for communicating through the network with a device connected to the network.

The user interface for inputting the data from the print control screen is divided into user interface parts, components of screen information such as icons, buttons, a scroll bar and a frame, and attribute information of the printers 16, expressed as text. The icon information is stored in the memory 12D of the scanner, and the attribute information of the printers 16 is stored in the server 14, as will be described below. By thus dividing the user interface into the icon information and the attribute information and by storing these separately in the scanner 12 and the server 14, the quantity of data to be transmitted from the server 14 to the scanner 12 can be reduced when the data composing the user interface is transmitted from the server 14 to the scanner 12. Therefore, the user interface can be quickly displayed in the display panel 12B. The memory 12D also stores programs for processing routines, which will be described later. The screen information can be generated in HTML (Hyper Text Markup Language).

Also, the user interface for displaying the print control screen may be not divided and stored, but all the information generated in the server 14 and transmitted to the controller 12C of the scanner 12.

Instead of the scanner 12, image data made electronically and stored in a recording medium such as a floppy disk or CD-ROM may be read and inputted. Further, using a personal computer, image data may be inputted from a facsimile or a database. Moreover, the image data may be inputted using mail software installed in the personal computer.

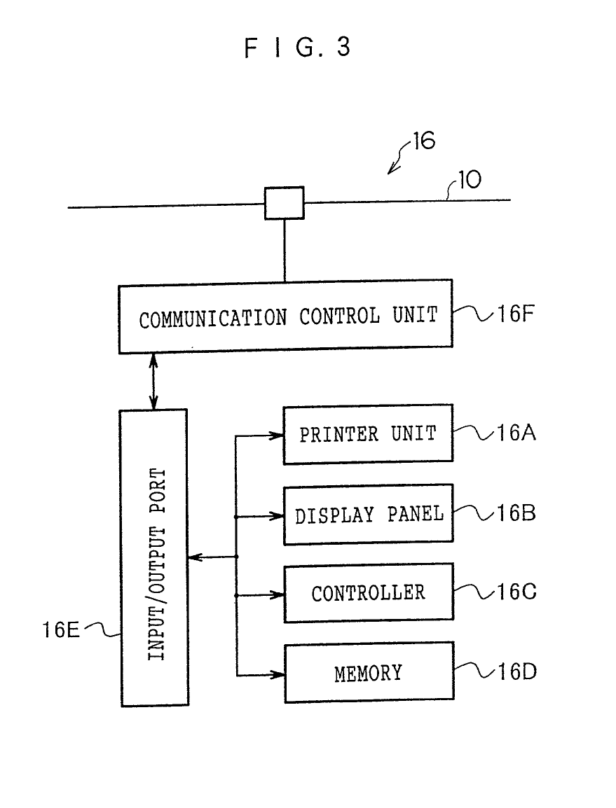

The printers 16₁ through 16ₙ are substantially similar in structure and are different only in attributes. Referring to FIG. 3, one printer will be described, omitting descriptions of the other printers. In the following, each individual printer will be called “the printer 16”, omitting suffixes, when they are described without any specific discrimination.

The printer 16 is provided, as shown in FIG. 3, with: a printer unit 16A for recording an electrostatic latent image on a photosensitive element, developing the electrostatic latent image with monochromatic toner or color toner, transferring the developed image to a recording paper or a recording medium, and outputting the recording paper; a display panel 16B such as a touch panel for displaying a control screen and for controlling the printer 16 by touching an icon on the displayed control screen; a controller 16C for controlling the printer 16 as a whole; a memory 16D for storing received image data and data of the output format; and an input/output port 16E for inputting/outputting the data. These printer unit 16A, display panel 16B, controller 16C, memory 16D and input/output port 16E are mutually connected through a bus. The input/output port 16E is connected to the network 10 through a communication control unit 16F for communicating through the network with a device connected to the network.

To the server 14, there are connected a driver 20, which is capable of writing (floppy disks or CD-RWs), for reading and inputting data recorded in an external storage unit such as a floppy disk drive, CD-ROM or CD-RW, a facsimile 22, and a database 24 stored with attribute information of all the printers 16 connected to the network.

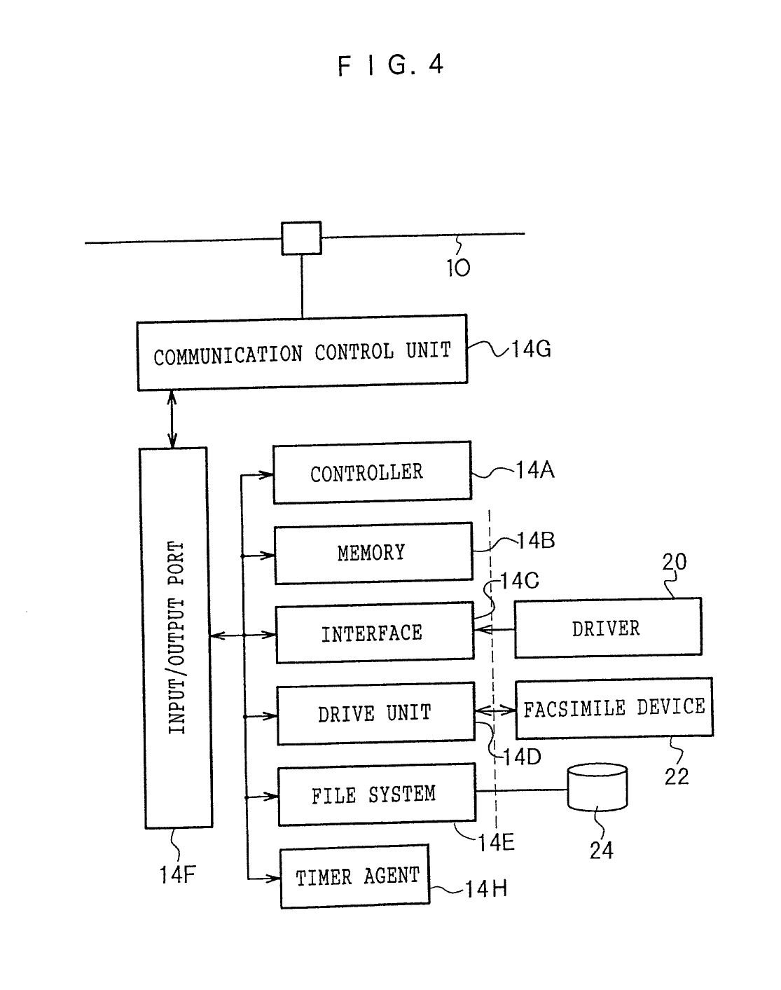

The server 14 is provided, as shown in FIG. 4, with: a controller 14A for controlling the server 14 as a whole; a memory 14B for storing the received data and storing in advance programs for controlling transmission and reception of a mailer and a facsimile unit to transmit and receive mails and programs of the later-described processing routines; an interface 14C connected with the driver 20 composed of a CD-ROM writer or the like; a drive unit 14D for driving the facsimile device 22; a file system 14E connected with the database 24; an input/output port 14F for inputting/outputting data; and a timer agent 14H. These controller 14A, memory 14B, interface 14C, drive unit 14D, file system 14E, input/output port 14F and timer agent 14H are mutually connected through a bus. The input/output port 14F is connected to the network 10 through a communication control unit 14G for communicating through the network with a device connected to the network. The communication control unit 14G functions to monitor (detect) the load condition, i.e., the communication condition, of the network 10.

The timer agent 14H functions as a timer to execute designated processes at designated times and to execute other designated processes periodically.

The database 24 may be connected with a database server which is connected to the network separately from the server 14.

Each of the clients 181 through 18n is structured by a personal computer which is provided with a communication control unit for communicating through the network with a device connected to the network.

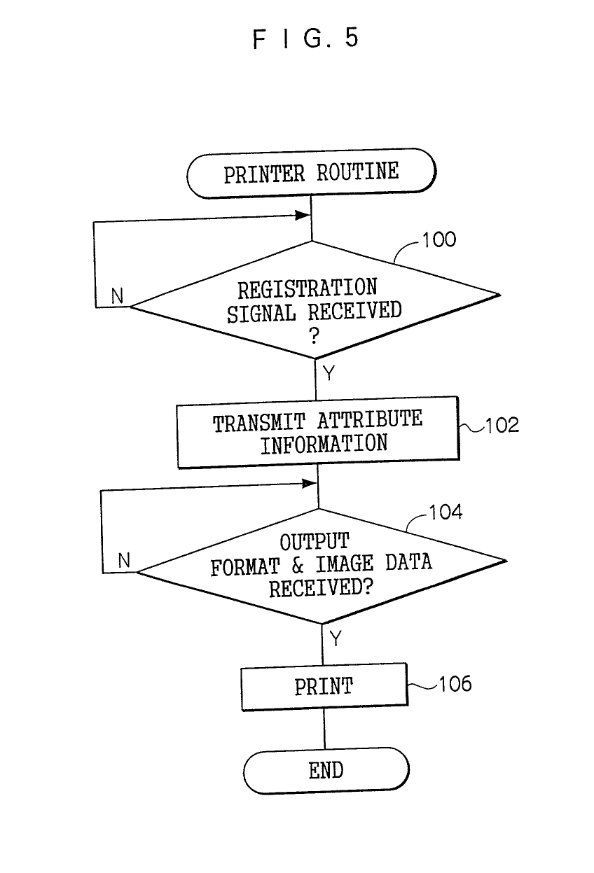

With reference to FIG. 5 to FIG. 7B, now will be described processing routines which are executed by the respective controllers of the scanner, the server and the printer of this embodiment. These processing routines are divided into individual routines for attribute information registering, control screen displaying, print instructing and printing, which will be separately described in the following.

### Attribute Information Registering Routine

The attribute information registering routine is for registering attribute information of the printer 16 connected to the network in the database connected to the server 14.

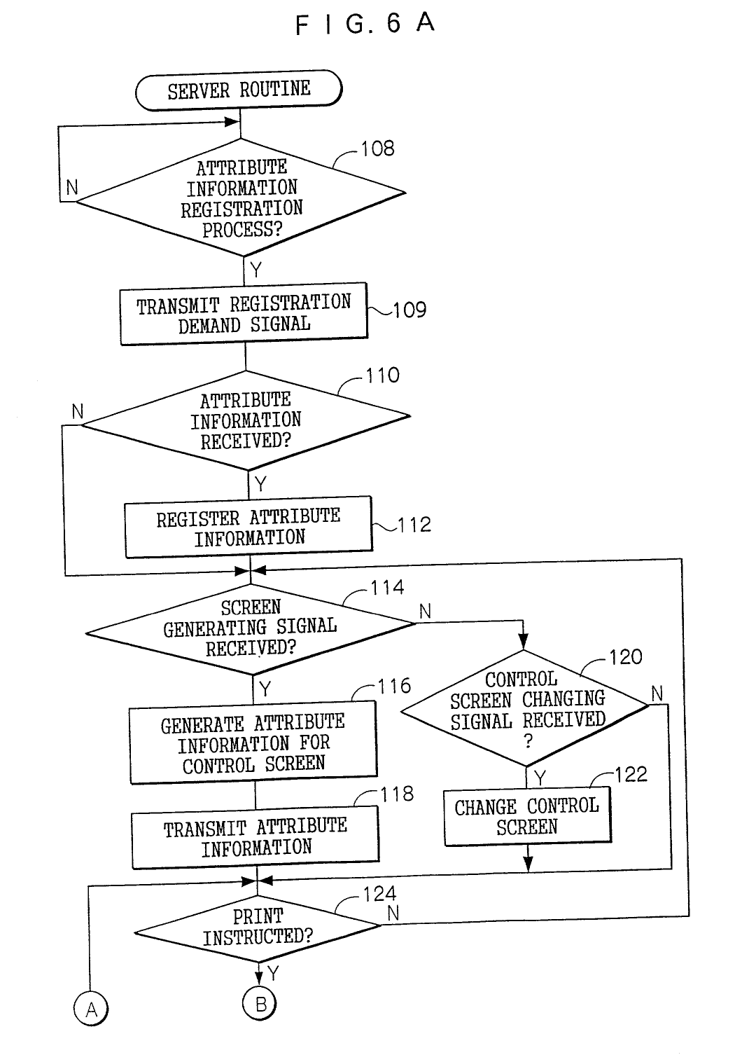

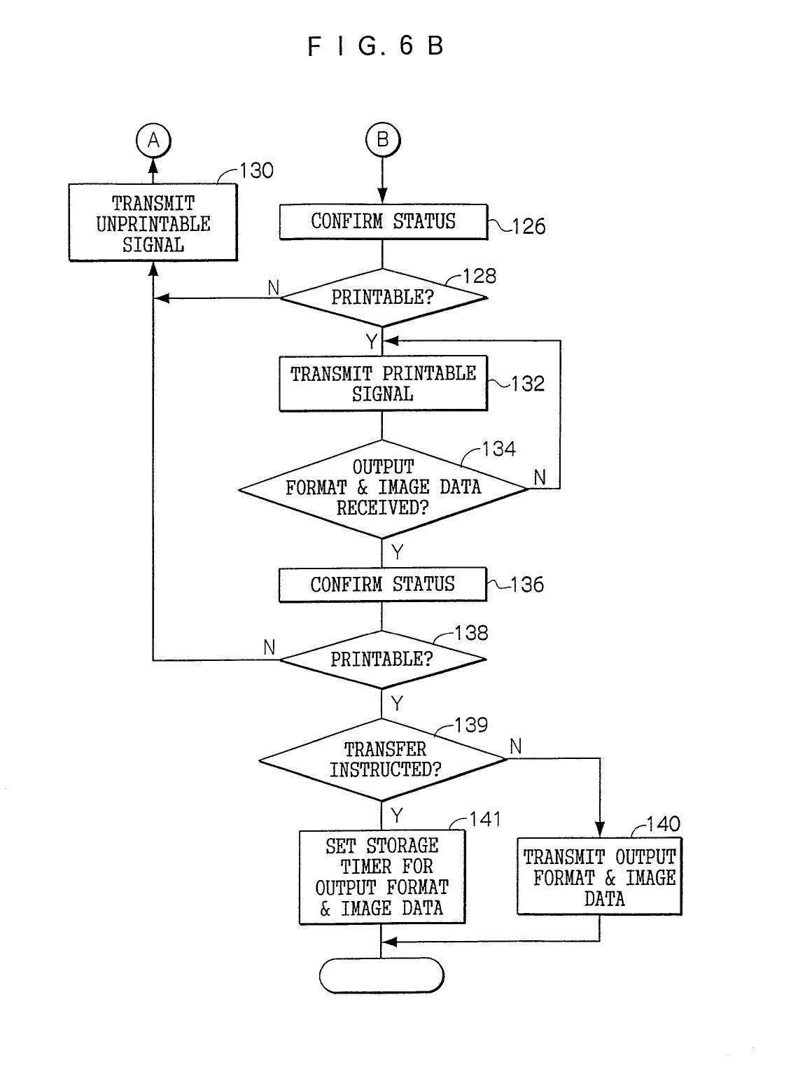

When the printer 16 is connected to the network 10, the attribute information registering routine for registering the attribute information of the printer 16 in th e server 14 is performed by controlling either a (not-shown) control panel belonging to the server 14 or administration tool software belonging to the server 14 from a client 18 which is connected through the network with the server 14. At the server 14, more specifically, if it is decided by an instruction of the administration tool software at Step 108 of FIG. 6A that attribute information registration is required, at Step 109 a registration demand signal demanding the registration of the attribute information is transmitted from the server 14 to the printer 16.

At the printer 16, it is decided at Step 100 of FIG. 5 whether or not the registration demand signal has been received. If the registration demand signal is received, at Step 102 the attribute information of the printer 16 is transmitted from the printer 16 to the server 14.

At Step 110 the server 14 decides whether or not the attribute information transmitted from the printer 16 has been received. If the attribute information is received, the file system 14E is controlled at Step 112 to register the attribute information of the printer 16 in the database 24.

When the printer 16 is connected to the network 10, the attribute information may be automatically transmitted from the printer 16 to the server 14 so that it can be automatically registered in the database 24. The attribute information of the printer 16 may be detected by the server 14 so that it can be registered in the database. Alternatively, the display panel 16B belonging to the printer 16 may be controlled for registering the attribute information of the printer 16 in the server 14. As a result, the database 24 connected with the server 14 is registered with the attribute information of all the printers 16 connected to the network 10.

The attribute information of the printer 16 is, for example, information indicating monochrome printing or color printing; information indicating whether or not double-sided printing function is available; information indicating whether or not a finisher (e.g., a stapling function or a punching function) is available; information indicating a high or low resolution; information indicating the printable size of paper; information indicating the kinds of fonts provided to the printer; in the case of a color printer, information indicating the output format of color characteristic information such as a color map or color adjusting information; information of location of each printer (e.g., the floor and location in one building or a location in a different building); information such as an IP address for setting the network; and information such as printer name information for identifying the printer. All the information on the output formats/conditions of the printer 16 is registered as the attribute information in the database.

### Control Screen Displaying Routine

When the scanner 12 is started, an initial screen is displayed at first on the display panel 12B of the scanner 12, and then a menu screen for service selection is displayed.

When the image data is inputted from an external storage unit, in which the image data was stored beforehand, an image reading routine is unnecessary, and the image data read from the external storage unit by a not-shown reading unit may be stored in the memory 12D.

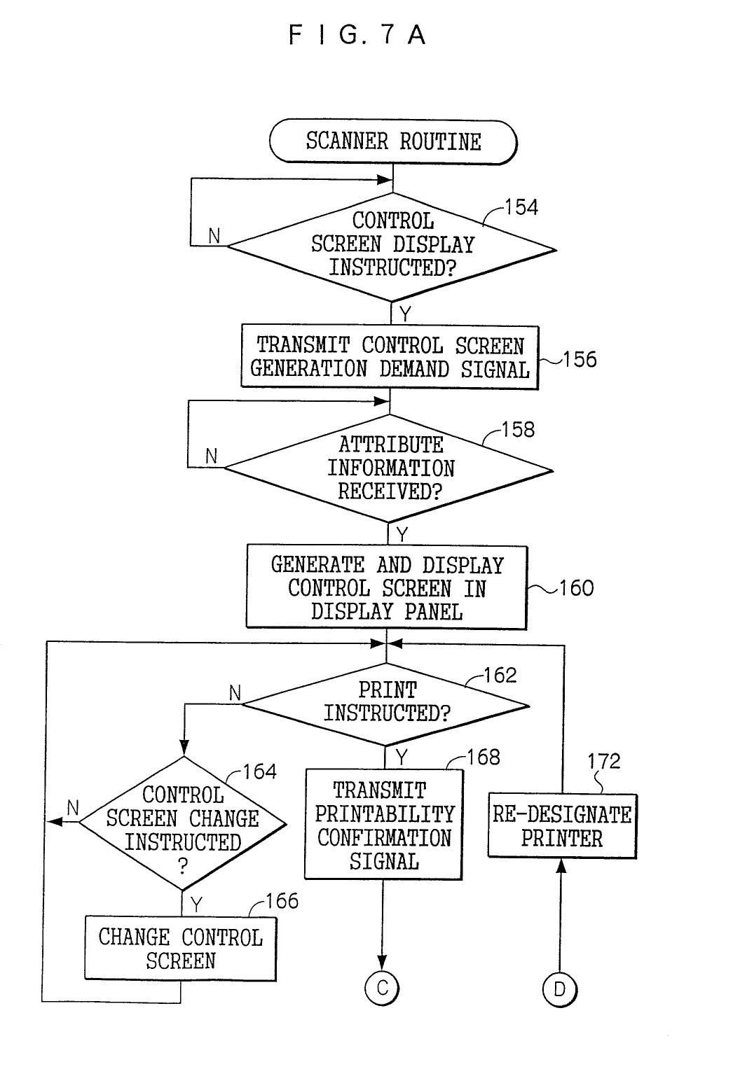

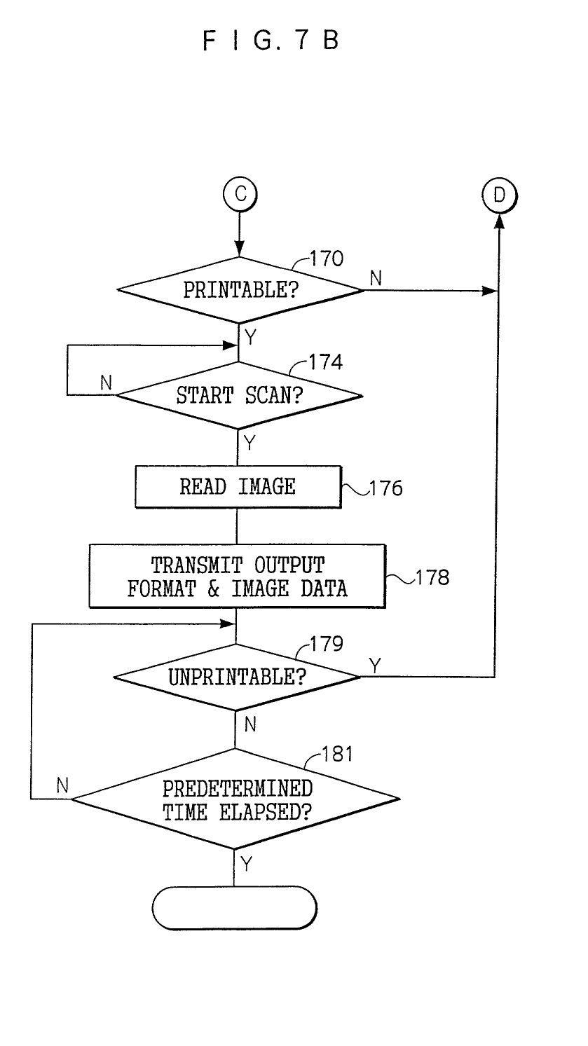

When printing is selected by an operator from a menu displayed in the display panel 12B of the scanner 12, it is decided at Step 154 of FIG. 7A that a print control screen display is instructed. At Step 156, a screen generation demand signal for generating the print control screen is transmitted from the scanner 12 to the server 14. Alternatively, just information indicating that a group of the printers 16 has been selected may be transmitted from the scanner 12 to the server 14.

If it is decided at Step 114 of FIG. 6A by the server 14 that the screen generation demand signal transmitted from the scanner 12 has been received, at Step 116 the status of the printer 16 connected to the network 10 is confirmed and the attribute information for generating the print control screen of the instructed printer is generated on the basis of the screen generation demand signal and the registered attribute information of the printer 16. At Step 118, the generated attribute information is transmitted to the scanner 12. As the screen generation demand signal, there can be transmitted a signal for displaying the attribute information of all the printers 16 connected to the network 10, for displaying only the attribute information those of the printers 16 that have a color printing function, or for displaying attribute information of only those of the printers 16 that are in a pre-designated group.

If it is found when confirming the status of the designated printer 16 that the printer 16 is disabled from printing by an error or the like, such as the power being off, a paper jam or an empty paper tray, the server 14 generates attribute information for generating the print control screen such that the attribute information of the disabled printer 16 is not displayed. Here, the disabled printer 16 may generate information for display on the print control screen to display error information indicating that printing is impossible on the printer 16.

When the attribute information is transmitted from the server 14 to the scanner 12 so that it is decided at Step 158 of FIG. 7A that the attribute information from the server 14 has been received, the scanner 12 generates the print control screen by synthesizing the received attribute information, expressed as text data for generating the print control screen, with user interface parts such as buttons stored in the memory 12D. At Step 160 the scanner 12 displays the generated print control screen as a user interface in the display panel 12B.

If the operator controls the displayed print control screen to instruct a screen change of the print control screen, the routine advances from Step 162 to Steps 164 and 166 of FIG. 7A, and from Step 114 to Steps 120 and 122 of FIG. 6A so that the screen is changed. In this screen change, a new screen generation demand signal is transmitted to the server 14, and the attribute information for generating a new print control screen by the server 14 is generated and transmitted, as has been described in connection with Steps 156 to 160 of FIG. 7A and Steps 114 to 118 of FIG. 6A. Therefore, the display of the print control screen is changed according to control applied to the print control screen of the display panel 12B of the scanner 12.

This screen changing routine is now described in more detail. A group of the printers 16 is selected by controlling the print control screen of the display panel 12B of the scanner 12 to designate the printers 16 belonging to the group, and a control screen generation demand signal for setting indication of output to the printers belonging to the designated group is transmitted. At the server 14, the logical product of the attribute information of the printers 16 belonging to the group is made so that the attribute information that is common to the individuals in the group can be selected and transmitted to the scanner 12. As a result, the print control screen for displaying the group of the printers 16 and the attribute information common to the group is newly generated and displayed. When a plurality of printers 16 are registered as one group, the operator selects attribute information expressing the function to be grouped. When a screen generating signal for displaying the printers 16 that have that attribute information is transmitted to the server 14, all the printers 16 having the selected attribute are displayed. Therefore, the operator can group the printers 16 as desired, by selecting them from the screen and by instructing the server 14 to make groups.

When an individual of the printers 16 is selected, its attribute information is selected at the server 14 and transmitted to the scanner 12 so that the print control screen for displaying the attribute information of the selected printer 16 is generated and displayed in the display panel 12B of the scanner 12.

Moreover, when the attribute information of the printers 16 to be outputted, i.e., the output conditions are designated to select the display of the printer 16 that is the most suitable for the conditions (the best fit), the server 14 makes a logical OR result of the attribute information of the printers 16 belonging to the group selected as the destination, and transmits the attribute information of the printers 16 on the basis of the made result to the scanner 12. The scanner 12 generates the print control screen and displays it on the display panel 12B. With this screen, the operator can examine all the attribute information that can be selected.

### Print Instructing Routine

The operator confirms the attribute information of the printers 16 by the print control screen and then instructs printing by setting output parameters indicating an image data output format, such as paper size or magnification, from the print control screen. As a result, it is decided at Step 162 of FIG. 7B that the printing is instructed. At Step 168, a printability confirmation signal for confirming whether or not the printing can be done by the designated printer 16 is transmitted to the server 14.

The printability confirmation signal is transmitted from the scanner 12 to the server 14, and it is decided at Step 124 of FIG. 6A that the printability confirmation signal has been received (that printing has been instructed). Then, at Step 126 the status of the designated printer 16 is confirmed. If, at Step 128, printability is determined from that status, at Step 132 a printable signal is transmitted to the scanner 12. If, on the other hand, unprintability is determined at Step 128, at Step 130 an unprintable signal is transmitted to the scanner 12.

In the scanner 12, it is decided at Step 170 of FIG. 7A whether or not the printable signal has been received. If the printable signal is received, it is decided at next Step 174 whether or not image reading (start scanning) has been instructed, by the operator pushing a start button. If the image reading instruction is determined at Step 174, at Step 176 the scanner unit 12A is controlled to read an image recorded in a set document by a single action; that is, a series of image data are read as common image data and are stored as electronic data in the memory 12D of the scanner. At Step 178, the output format inputted from the control screen and the image data read from the scanner unit 12A are transmitted to the server 14.

If, on the other hand, it is decided at Step 170 that the unprintable signal has been inputted, at Step 172 the operator is instructed to re-designate the printer 16. When the operator controls the display panel 12B to re-designate the target printer 16, the routine advances as before from Step 162 to Step 168 and the printable confirmation signal for confirming printability is transmitted to the server 14. When the printable signal is received at Step 170 and it is decided at Step 174 that the image reading has been instructed, the image data recorded in the document is read at Step 176, and the output format and image data are transmitted to the server 14 at Step 178.

The designation of the printers 16 can be, for example, designating one printer 16 or designating a group and causing the individual printers 16 belonging to the designated group to output prints simultaneously.

Although not detailed until later herein, a printer of another print system can be designated by instructing transfer of the job. In this case, the date and time of transferring the job can be designated so as to transfer the job at the designated date and time to the other print system to be executed.

Further, a plurality of the printers 16 having different functions as their attributes may be preset to belong to a group so that prints may be individually outputted from one of the printers 16 having the color outputting function or one of the printers 16 having the monochromatic outputting function. In this case, the cost can be made lower than a case in which all prints are outputted in color, by designating the outputs so that some prints are outputted from the printer 16 having the color outputting function and the other prints are outputted from the printer 16 having the monochromatic outputting function.

Furthermore, it is possible to designate numbers of output prints by size (e.g., one print in A4 and the remaining prints in B4), to designate numbers of output prints by recording faces (e.g., one print double-sided and the remaining prints single-sided), and to designate numbers of output prints by use or non-use of the finisher (e.g., one stapled print and the remaining prints unstapled).

When an instruction is made to execute one job in a plurality of printers 16, jobs of the individual printers 16 are made independent of one another in a lower layer of the one job, so that a job of an upper layer and all the jobs of the lower layer can be likewise executed by controlling (to start, stop, restart, change or delete) the job of the upper layer. Moreover, it is possible to execute the jobs of the lower layer independently of one another by controlling them independently of one another.

### Printing Routine

If it is decided at Step 134 of FIG. 6B that the output format and the image data from the scanner 12 have been received at the server 14, the status of the printer 16 designated to execute the job is confirmed at Step 136, and it is decided at Step 138 from the confirmed status whether or not the printer 16 is printable. If the printer 16 designated to print generates an error so that it cannot print, at Step 130 the unprintable signal is transmitted to the scanner 12. Thus, in the scanner 12, at Step 179 after the transmission of the output format and the image data it is decided that the unprintable signal has been received. Thus, at Step 172, as described above, the operator is instructed by the control screen to re-designate the printer 16. The operator controls the display panel 12B to re-designate the printer 16 for output. When the printable signal is received and scanning start is instructed, the image is read and the output format and the image data are transmitted again to the server 14. Moreover, until it is decided at Step 181 that a predetermined time has elapsed, the routine keeps returning to Step 179, at which it is repeatedly decided whether or not the unprintable signal has been received.

Here, even if the printer 16 is re-designated after the output format and the image data have been transmitted from the scanner 12 to the server 14, it is usual that the output format and the image data are not changed. Therefore, the output format and the image data need not be transmitted again, and the output format and the image data having already been transmitted to the server 14 may be utilized as they are. On the other hand, if the output format has been changed during re-designation of the printer 16, the output format alone may be transmitted and changed.

When the printability is determined at Step 138, at Step 139 it is decided whether or not a job transfer has been instructed, as will be detailed below. If the transfer is instructed, the routine advances to Step 141. If not, at Step 140, an image data output format signal indicating the paper size, the print number and so on, and the image data inputted from the scanner 12 are transmitted through the network 10 from the server 14 to the printer 16 designated to print. At Step 104 of FIG. 5, if it is decided that the output format and the image data transmitted from the server 14 have been received, at Step 106 the printer 16 records an image, based on the image data, on the recording paper in the output format, and outputs the recording paper having the formed image.

Now will be described the flow of a printing job when a plurality of the above-described print system is connected through the network 10, e.g., when a print system 11X at a head office and a print system 11Y at a branch office are connected through the network 10.

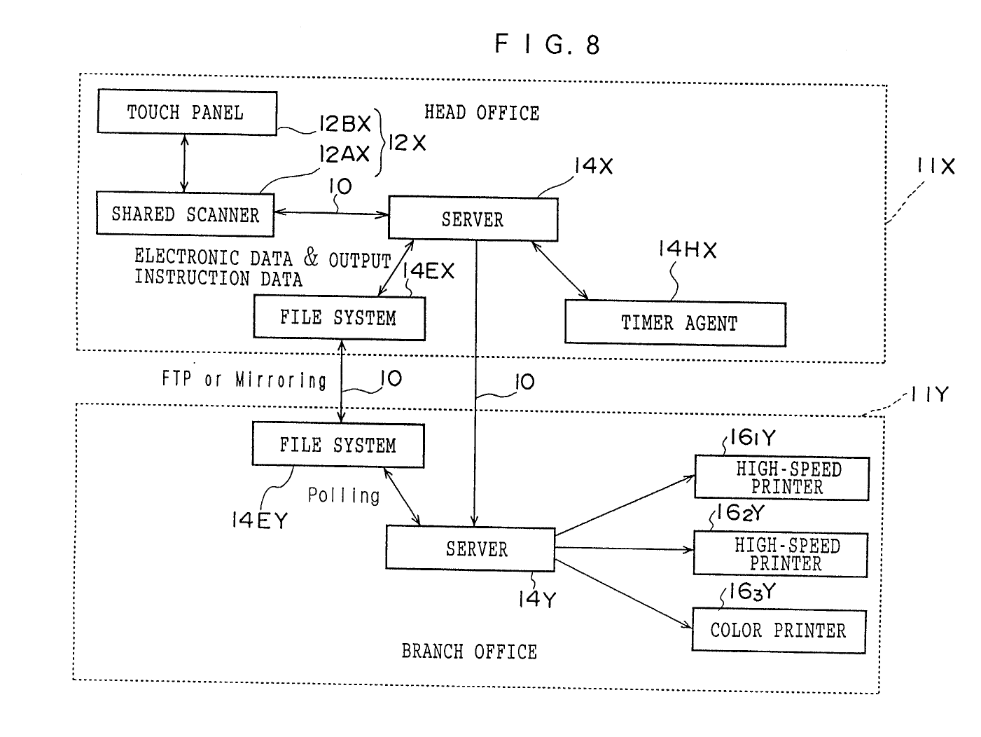

The print systems 11X and 11Y shown in FIG. 8 have structures similar to that of the print system 11 previously described. FIG. 8 shows only structures necessary for description and omits other structures for simplicity of description. In the following, moreover, the individual units of the print system at the head office and at the branch office have their reference numerals suffixed by X and Y, respectively, so that the individual units of the print system 11X at the head office and the print system 11Y at the branch office may be discriminated.

In the print system 11X at the head office, as shown in FIG. 8, a server 14X is connected through the network 10 with a scanner 12X including a touch panel (display panel) 12BX and a shared scanner (scanner unit) 12AX. The server 14X is provided with a timer agent 14HX and a file system 14EX.

In the print system 11Y at the branch office, a server 14Y is connected with high-speed printers 16₁Y and 16₂Y and a color printer 16₃Y. Also, the server 14Y is provided with a file system 14EY.

The server 14X at the head office and the server 14Y at the branch office, and the file system 14EX at the head office and the file system 14EY at the branch office are connected through the network 10.

The file system 14EX at the head office functions, for example, as an FTP (File Transfer Protocol) server with the file system 14EY at the branch office functioning as an FTP client. In other words, a file stored in the file system 14EX at the head office can be FTP-transferred to the file system 14EY at the branch office.

Here, mirroring software may be installed in the file system 14EX at the head office and the file system 14EY at the branch office to effect mirroring, in which, when data is written to the file system 14EX at the head office, the same data is written to the file system 14EY at the branch office.

In the case of this system in which a plurality of print systems are connected through the network, the routine of registering attribute information, the control screen displaying routine of the, the print instructing routine and the printing routine can be performed as in the previous description.

In the attribute information registering routine, for example, the printer 16 at the branch office may, at Step 102 of FIG. 5, transmit the attribute information through the server 14Y to the server 14X at the head office. In the server 14X at the head office, attribute information transmitted from the server 14Y at the branch office at Step 112 of FIG. 6A is registered in the file system 14EX. In the scanner 12 at the head office, therefore, the printer at the head office and the printer at the branch office can be instructed to print without any differentiation.

Now will be described a case in which image data read by the scanner 12 at the head office is transmitted to the branch office at a designated time.

First of all, at the head office, a user instructs the scanner 12 to read an image to be outputted to the printers at the branch office, such as the color printer 16₃Y, and to transmit the read image to the branch office at night. At Step 141 of FIG. 6B, the server 14X stores the output format and the image data as a transfer job in the file system 14EX, and sets a timer to flag an event at a transfer date and time designated in the timer agent 14HX (e.g., a time at night).

When, at the designated transfer date and time, the server 14X is informed of the event by the timer agent 14HX, the file system 14EX FTP-transfers the transfer job to the file system 14EY at the branch office.

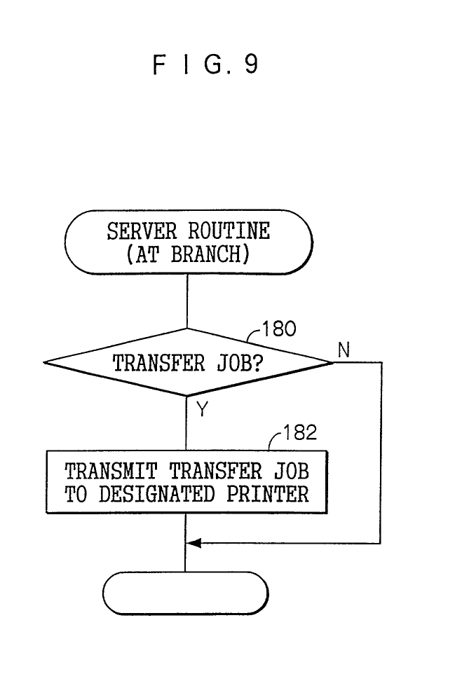

In the server 14Y at the branch office, a control routine shown in FIG. 9 is executed at predetermined intervals. As shown in FIG. 9, more specifically, it is decided at Step 180 whether or not a transfer job has been transferred from the file system 14EX at the head office to the file system 14EY.

When the transfer job is transferred from the file system 14EX at the head office to the file system 14EY, at Step 182 the transfer job is transmitted to the designated printer, such as the color printer 16₃Y.

Thus, it is possible to designate the transfer date and time at which the job is transferred from the head office to the branch office. Therefore, many copy jobs can be transferred to the branch office at night when the load on the network is light, so that the jobs can be efficiently distributed and processed without making the load on the network heavy.

Above has been described the case of a night transfer of the job from the server at the head office to the server at the branch office. However, a job may also be transferred at night from the server at the branch office to the server at the head office.

On the other hand, the job may be not transferred immediately at the designated transfer date and time, but the loading condition (communication condition) of the network 10 monitored first. If it is decided that the load (amount of communication) on the network exceeds a predetermined threshold value, the transmission maybe delayed until the load on the network becomes lower than the threshold value and the transfer job may be transmitted when the load is below the threshold value. As a result, it is possible to transfer the transfer job efficiently.

### Second Embodiment

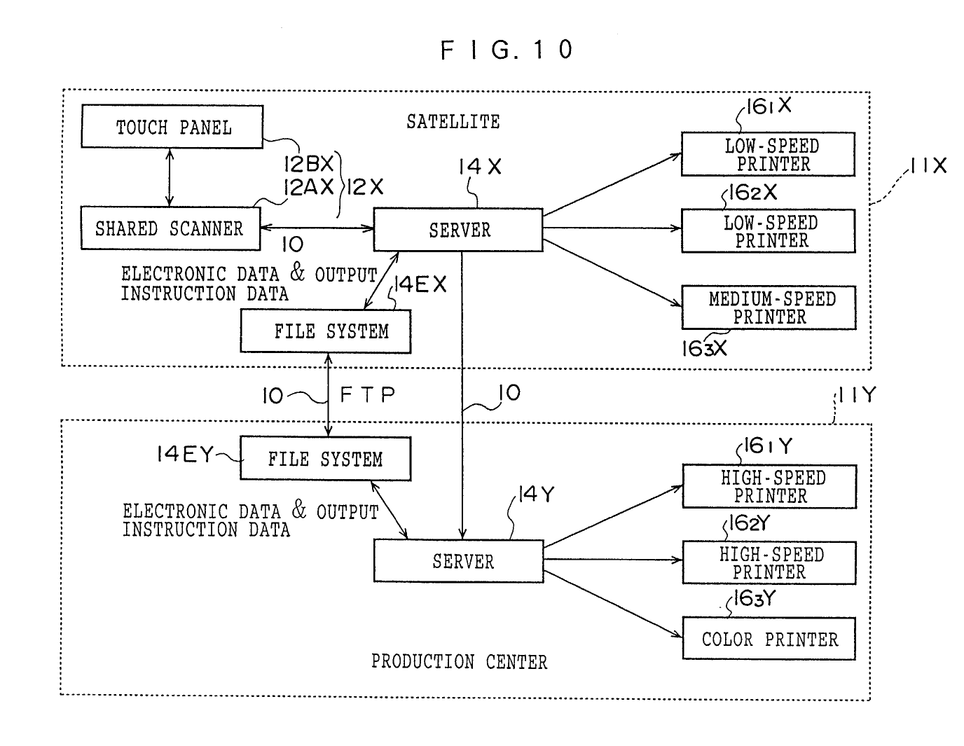

Now, a second embodiment of the present invention will be described. This second embodiment will be described for a case in which jobs are distributed between a production center for a copy service and a satellite shop, with reference to FIG. 10. Here, the system shown in FIG. 10 basically has the same structure as that of the system shown in FIG. 8, and detailed description of common portions, which are designated by common reference numerals, will be omitted.

As shown in FIG. 10, a print system 11X of the satellite shop and a print system 11Y of the production center are given substantially similar structures. The print system 11X of the satellite shop is provided with low-speed printers 16₁X and 16₂X and a medium-speed printer 16₃X and is a system for processing relatively small jobs. The print system 11Y of the production center is equipped with high-speed printers 16₁Y and 16₂Y and a color printer 16₃Y and is a system for processing relatively large jobs and high-function jobs such as color copying and the like.

Here, a control routine to be executed at the server 14Y of the satellite shop will be described. Detailed description of operations the same as those of the control routine shown in FIG. 6A and FIG. 6B, which are designated with common reference numerals, will be omitted. The control routines to be executed by the printers of the satellite shop and the production center can be made identical to that described in the first embodiment and shown in FIG. 5. The control routine to be executed by the server 14Y at the production center can be made identical to that described in the first embodiment and shown in FIG. 6A and FIG. 6B. The control routine to be executed by the scanner 12X at the satellite shop can be made identical to that described in the foregoing embodiment and shown in FIG. 7A and FIG. 7B. Therefore, detailed description of those control routines will be omitted.

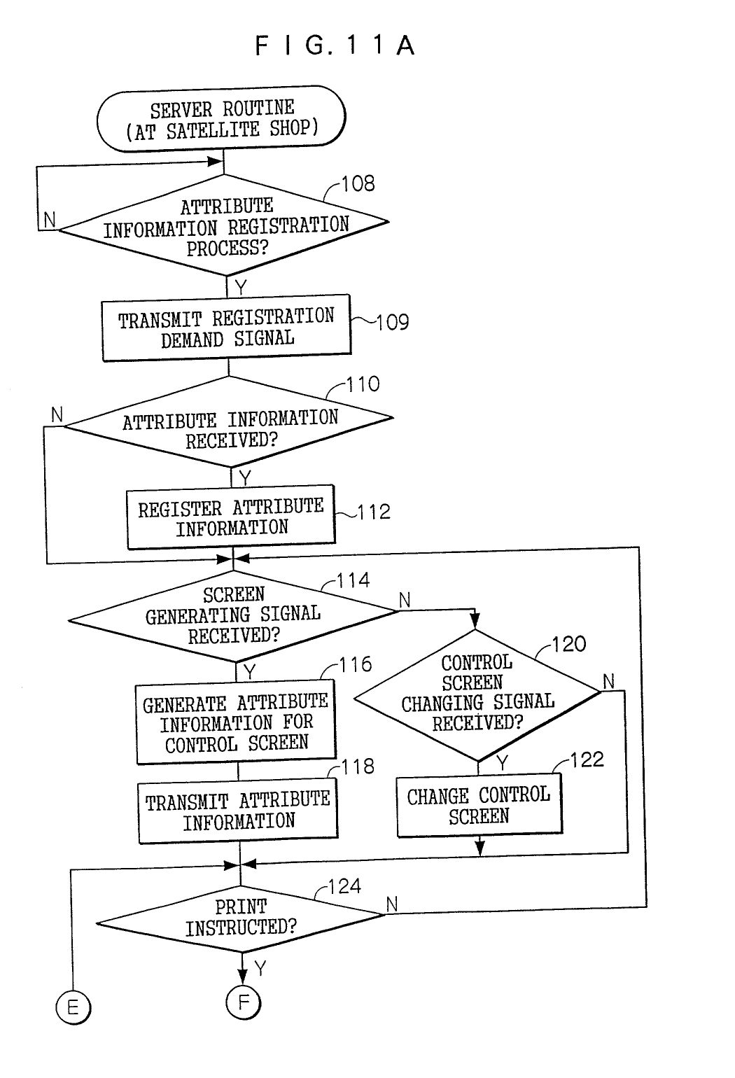

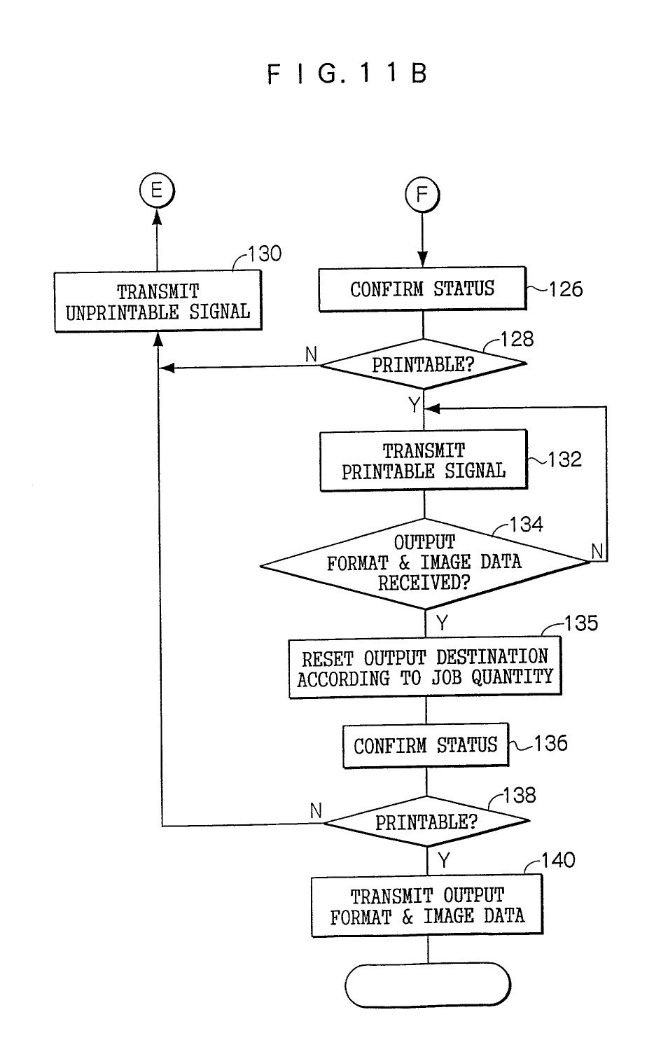

In the server 14X at the satellite shop, as shown in FIG. 11A and FIG. 11B, when it is decided at Step 134 that the output format and the image data from the scanner 12 have been received, at Step 135 the output destination is reset according to a job amount determined from the output format and image data. That is, at Step 135 it is decided whether or not the job amount is larger than a predetermined value. Specifically, whether or not the job amount is larger than the predetermined value is decided, for example, by deciding whether or not the output number included in the output format is larger than a predetermined value or by whether or not the size of the received image data is larger than a predetermined value. These predetermined print number value and predetermined size value are determined according to the processing capacities of the satellite shop and the production center. Specifically, it is decided at Step 135 whether the received job is to be processed at the satellite shop or at the production center.

When the job amount is larger than the predetermined value, that is, the output number contained in the output format is larger than the predetermined output number value, the size of the received image data is larger than the predetermined size value or the like, it is decided that processing at the production center is appropriate. If the output destination has been set to a printer at the satellite shop, the output destination is reset to a printer at the production center. On the other hand, when the job amount is not larger than predetermined value, that is, the output number contained in the output format is not larger than the predetermined output number value, the size of the received image data is not larger than the predetermined size value or the like, it is decided that processing at the satellite shop is appropriate. If the output destination has been set to the printer at the production center, the output destination is reset to the printer at the satellite shop.

Then, at Step 136, the status of the printer 16 to which the execution of the job has been designated is confirmed. At Step 138, it is decided from the confirmed status whether or not the job is printable. If printable, at Step 140 transmission through the network 10 to the job-designated printer 16 is performed.

When the output designation is the printer at the production center, the job is FTP-transferred from the file system 14EX to the file system 14EY at the production center and is transmitted from the server 14Y to the designated printer 16.

Thus, whether the routine is processed at the print system or at the satellite shop is set according to the job amount. Therefore, each job can be efficiently distributed and processed.

Above has been described the case in which a large job is transferred to the production center unaltered. It is, however, possible, for example, to preset a print output number limit of prints that can be outputted by the printer at the satellite shop, so that only prints beyond the limit value are processed at the production center, i.e., so that one job may be divided and processed.

Further, the job may be not transferred immediately, but the load condition of the network 10 monitored first. If it is decided that the load on the network is higher than a predetermined threshold value, transmission may be delayed until the load on the network becomes lower than the threshold value and then the job may be transferred. As a result, the job can be transferred efficiently.

### Third Embodiment

Here will be described an electronic filing routine according to a third embodiment of the present invention. Detailed descriptions of the print system (FIG. 1 to FIG. 4) the attribute information registering routine, the scan screen displaying routine and the print instructing routine and the printing routine (FIG. 7A to FIG. 9B) that are generally similar to those of the first and second embodiments will be omitted, employing the same reference numerals. In the following, the third embodiment will be described in detail for portions which require more detailed description than in the first and second embodiments and which are different from those of the first and second embodiments.

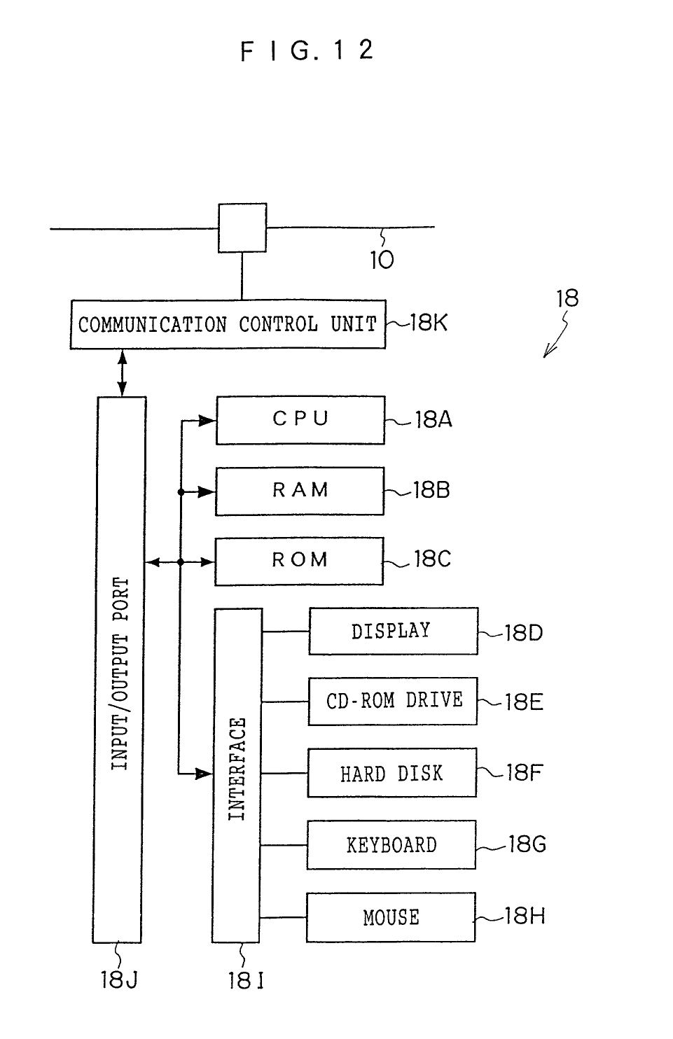

As shown in FIG. 12, a personal computer 18 (one of the clients 18₁ through 18ₙ) is provided with: a CPU 18A for controlling the personal computer 18 as a whole; a RAM 18B; a ROM 18C stored in advance with programs of a later-described processing routine and the like; an interface 18I having a display 18D, a CD-ROM drive 18E, a hard disk 18F, a keyboard 18G, and a mouse 18H connected therewith; and an input/output port 18J. The CPU 18A, the RAM 18B, the ROM 18C, the interface 18I and the input/output port 18J are connected to the network 10 through a communication control unit 18K for communications through the network with devices connected to the network.

Here, the server 14 can function as a WWW (World Wide Web) server, and the client 18 can function as a WWW client. Specifically, a WWW browser is installed in each client 18 so that the client 18 is enabled to freely access the server 14 through the network 10 by launching the WWW browser. At this time, an access position (i.e., data composed of the position of the server 14 to be accessed and the position in the server 14 of the information to be accessed) is designated by a URL (Uniform Resource Locator).

In the case of an access demand by the client 18, the server 14 transmits data at the position designated by the URL through the network 10 to the access source client 18. At this time, the data is generally transferred according to HTTP (Hyper Text Transfer Protocol).

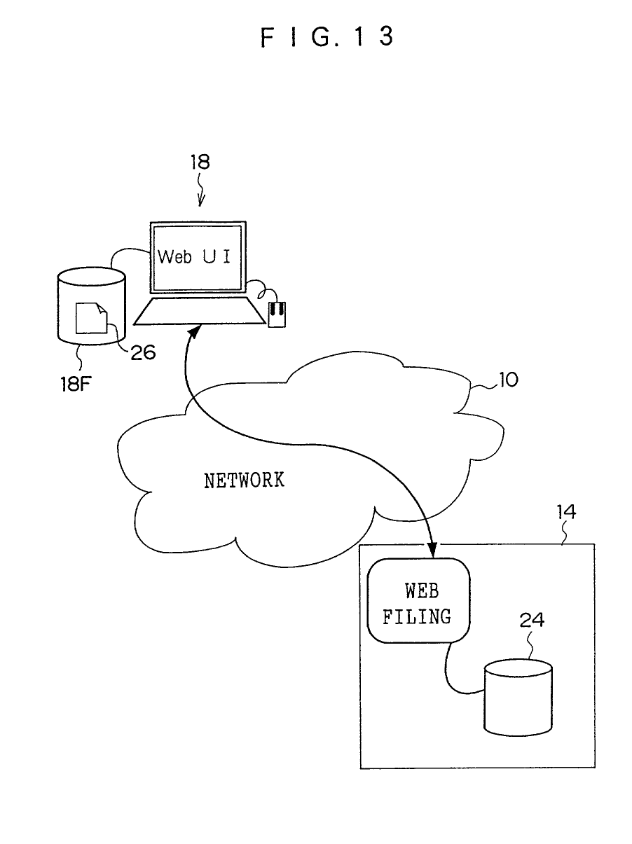

By thus causing the server 14 to act as a WWW server and the client 18 to act as a WWW client, as shown in FIG. 13, the client 18 is enabled to access the server 14, and can file a reprinting file 26 stored in the hard disk 18F over the web, through the network 10, to the database 24 of the server 14.

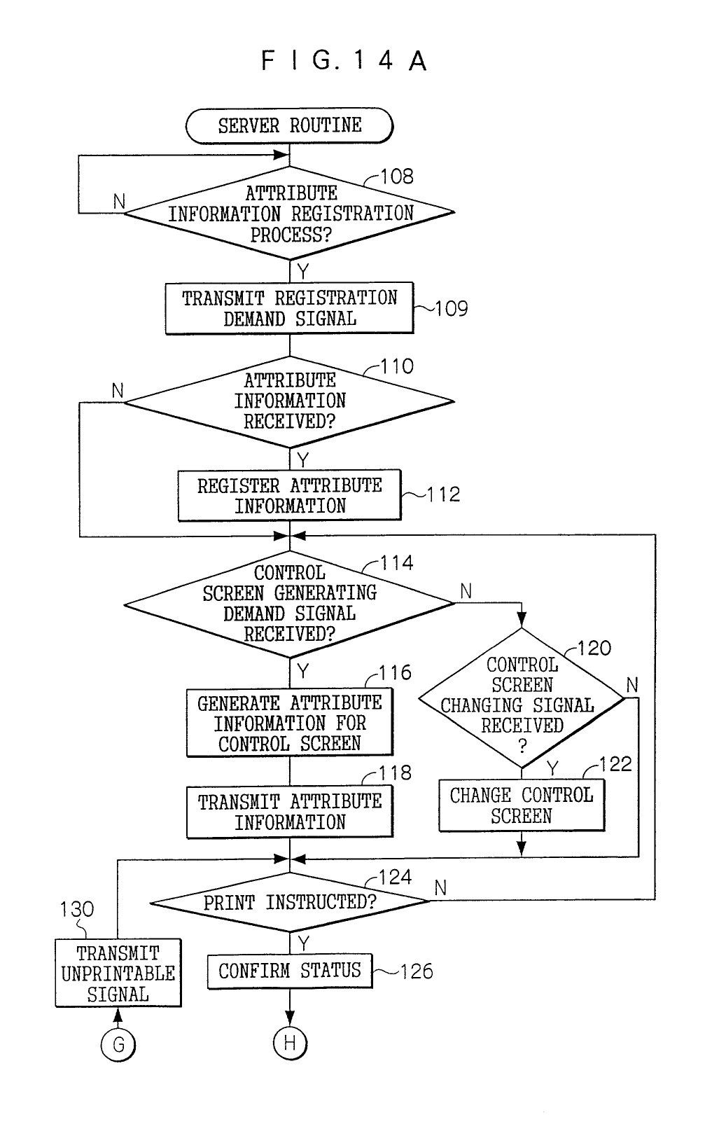

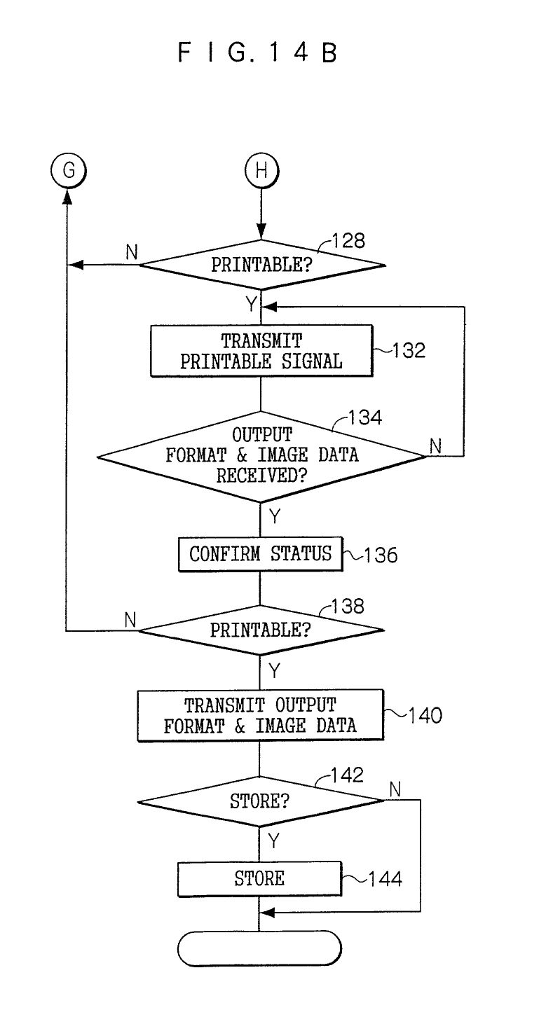

The routine of the server, shown in FIG. 14A and FIG. 14B, has a structure similar to that of the routines of the servers of the first and second embodiments, shown in FIG. 6A and FIG. 6B, but is different at and after Step 140. Specifically, at Step 142 it is decided whether or not, as well as the printing instruction, a storing instruction should be made by the scanner 12. If storage is instructed, at Step 144 the received image data and output format are stored as a reprinting file in the database 24 by controlling the file system 14E. This reprinting file can be reprinted by an instruction from the scanner 12, the client 18 or the like.

### Electronic Filing Routine

Here will be described an electronic filing routine. In this electronic filing routine, a user files (stores) the document data to be printed and options information for the document, by connecting the computer, acting as a WWW client, with the server 14, acting as a WWW server. An operator outputs the document data stored in the server 14 and the options information for the document to the printer 16, and prints using the computer as the WWW client. Herein, by suffixing the numeral with the letter U or O the user client is differentiated as client 18U, and the operator client is differentiated as client 18O.

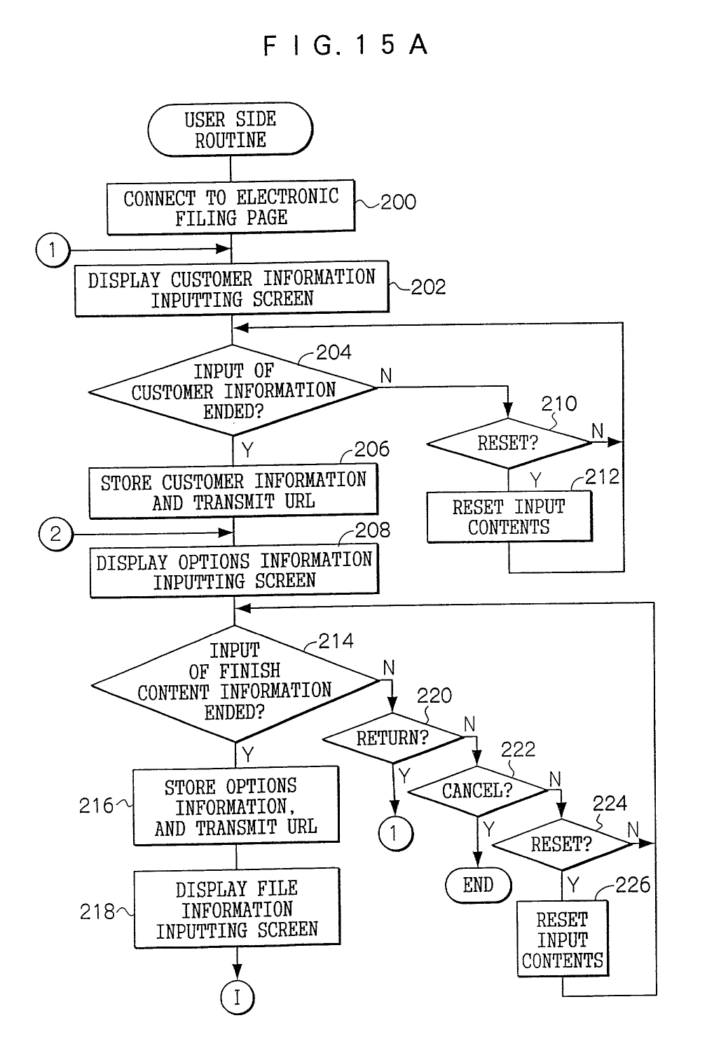

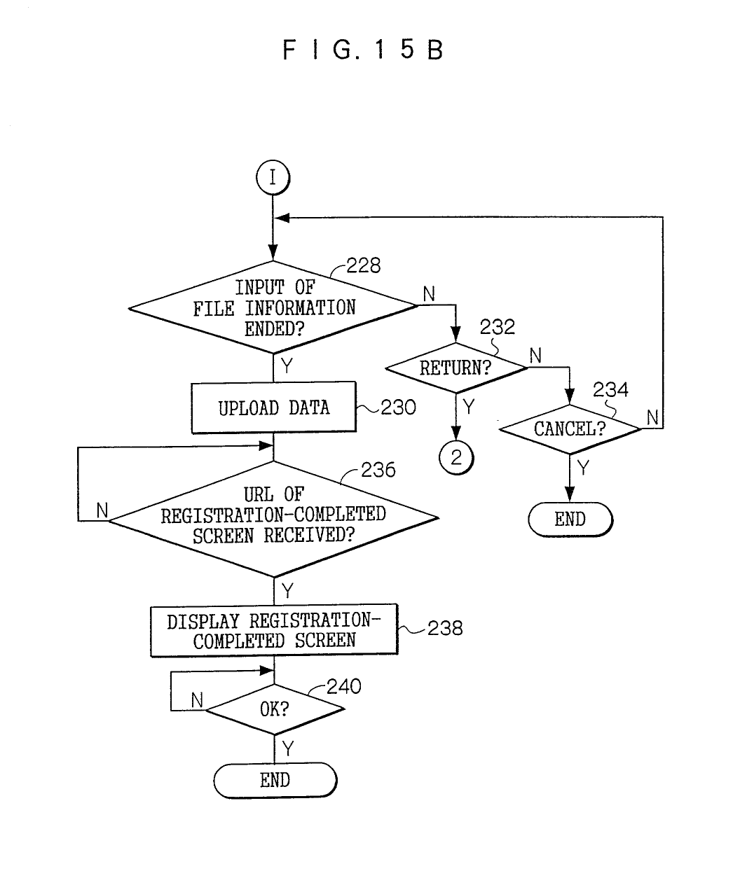

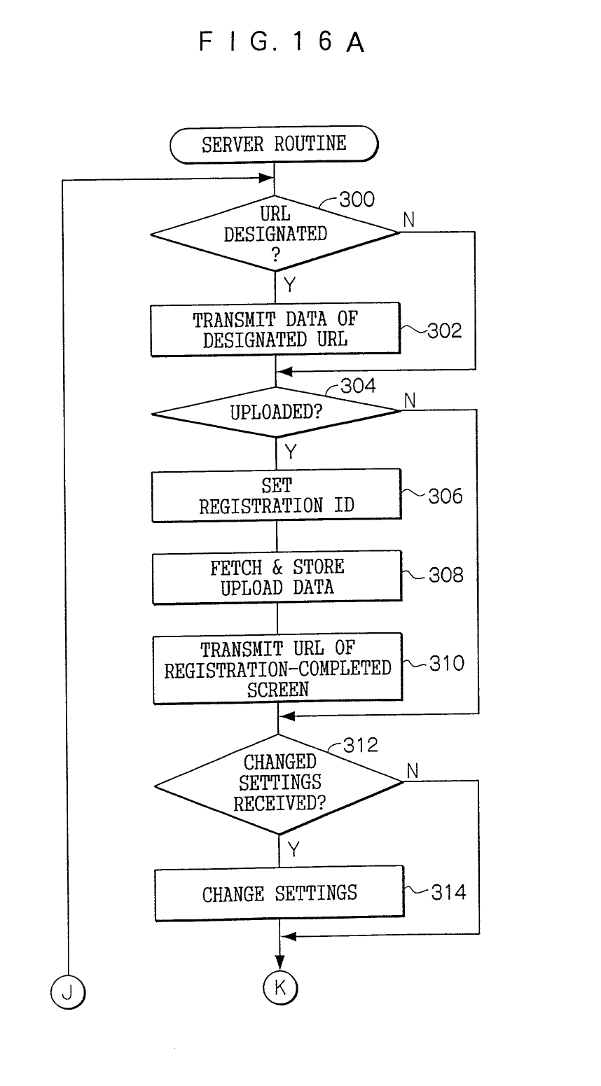

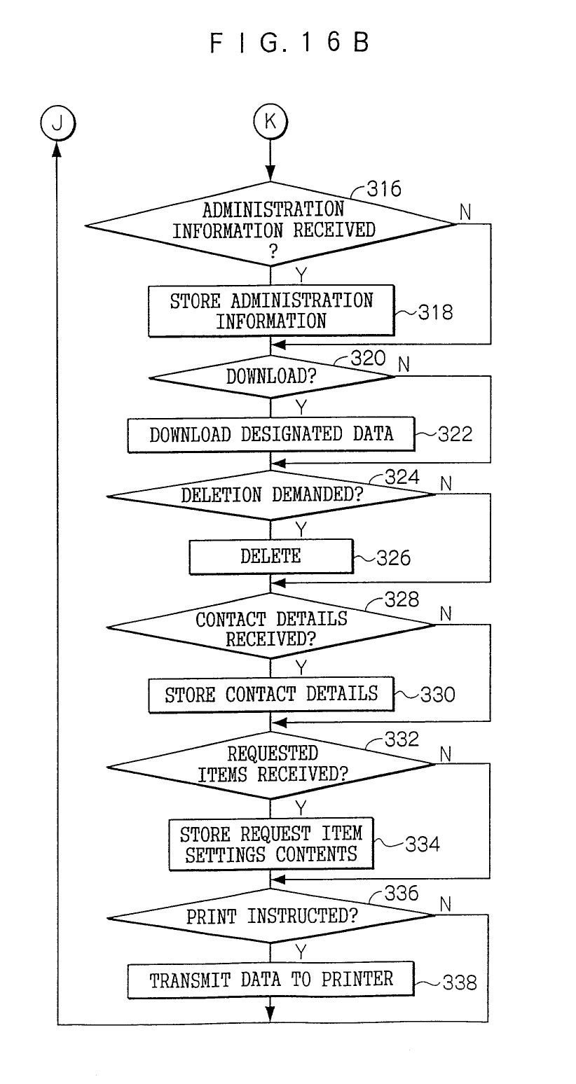

Now, the processing routines to be executed by the client 18U, the server 14 and the client 18O will be described with reference to FIG. 15A through FIG. 20B. At first Step 200 shown in FIG. 15A, the user controls the client 18U to access the electronic filing page in the server 14, i.e., the user designates the URL of the electronic filing page. At the server 14, it is decided at Step 300 of FIG. 16A that the URL of the electronic filing page has been designated, and at step 302 the data of the designated URL is transmitted to the client 18U.

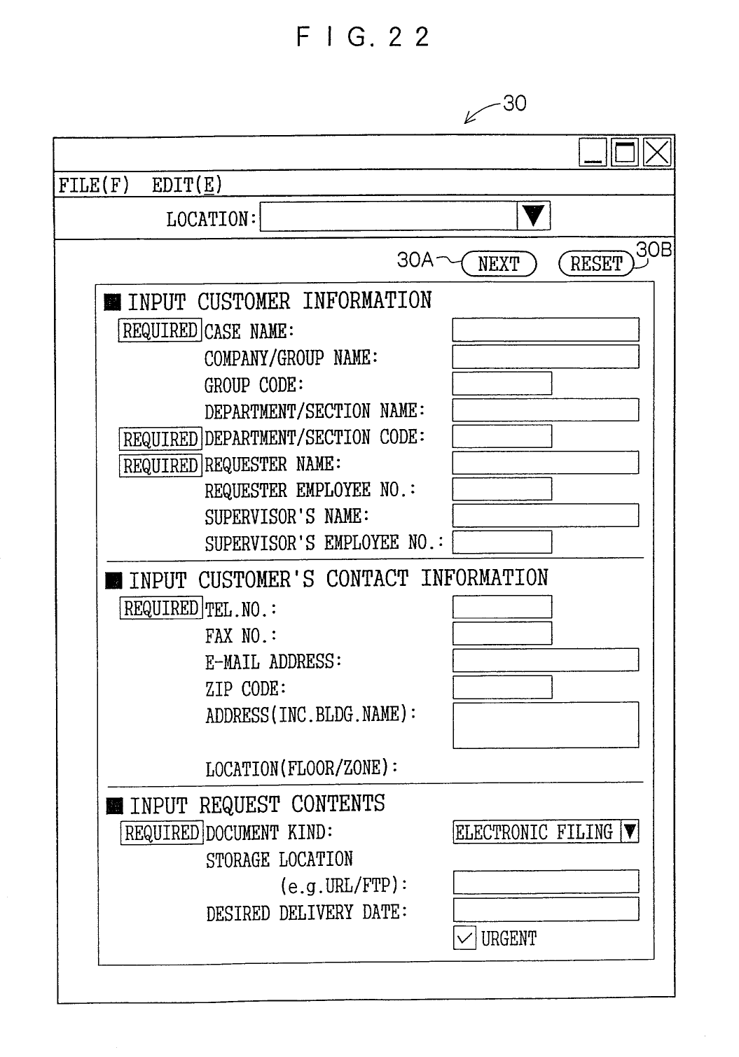

At the client 18U, at Step 202 of FIG. 15A, a customer information inputting screen 30, shown in FIG. 22, is displayed on the basis of the data transmitted from the server 14. That is, at Step 302 the server 14 transmits display data for displaying the customer information inputting screen. This display data is usually provided in an HTML (Hyper Text Markup Language) file.

In the customer information inputting screen, as shown in FIG. 22, there are prepared fields for inputting customer information (e.g., request case name and requester name), a customer's contact information (e.g., telephone number and address) and request details (e.g., document kind, storage location and desired delivery date).

For the document kind, it is possible to designate electronic filing (upload), URL/FTP or document delivery. When URL/FTP is designated for the document kind, it is useful to input a storage location.

Details that must be inputted are indicated by “Required” adjacent thereto. When the user clicks a “Next” button 30A after inputting at least the required items, it is decided at Step 204 that the inputting is ended. At Step 206, the input information is initially stored in a RAM 18BU, and the URL of a next screen corresponding to the “Next” button 30A is transmitted to the server 14.

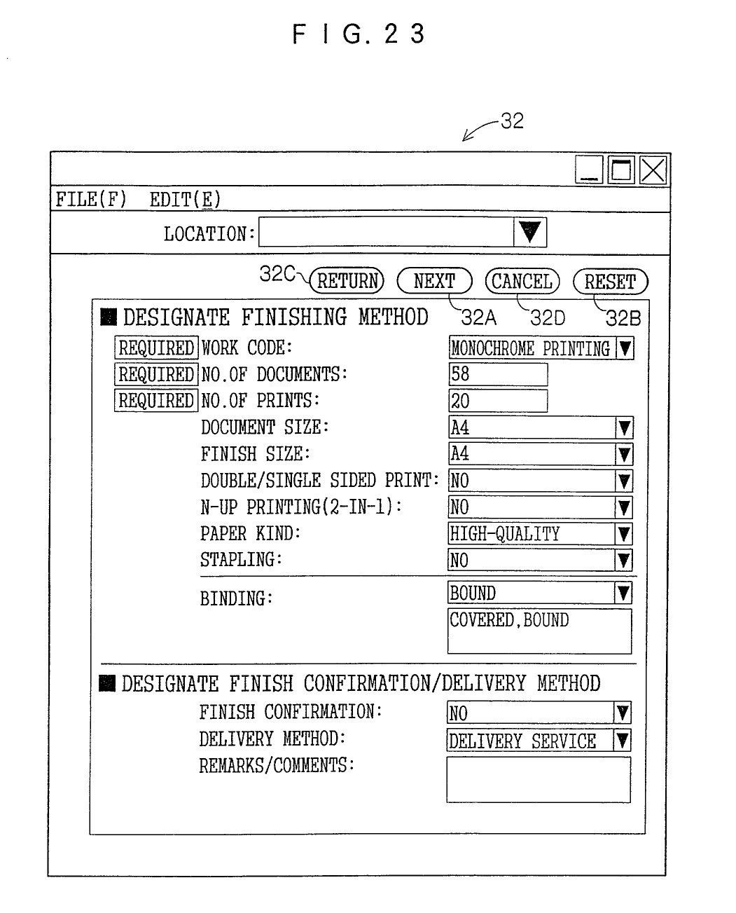

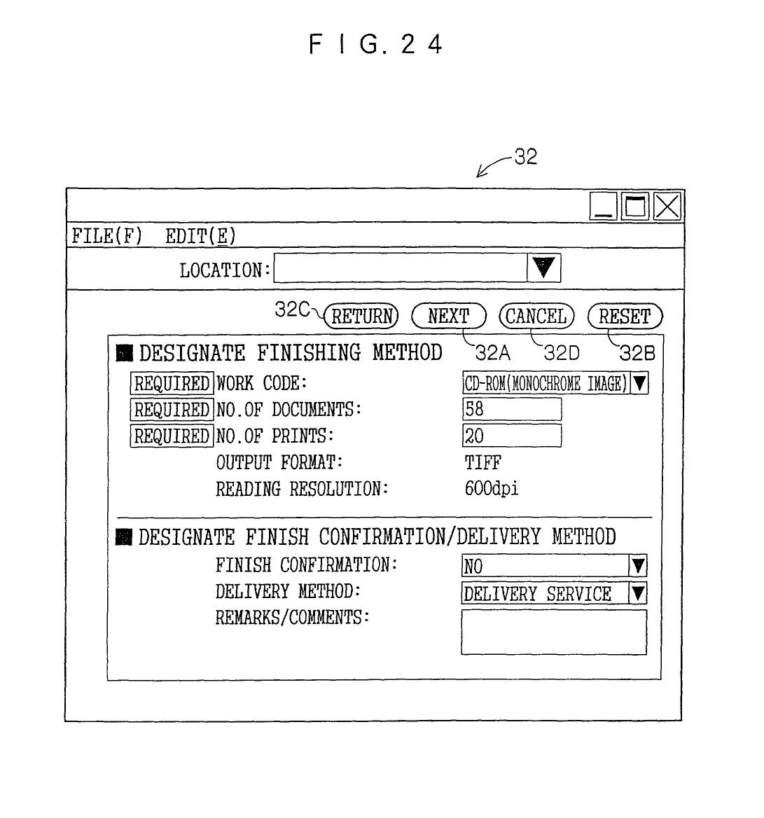

At the server 14, it is decided at Step 300 of FIG. 16A that the URL has been designated, and at step 302 the data of the designated URL is transmitted to the client 18U. In the client 18U, an options information inputting screen 32, as shown in FIG. 23 or FIG. 24, is displayed at Step 208.

If a “Reset” button 30B is clicked, the result of step 210 is affirmative, and at Step 212 the input details are reset so that the details can be inputted from the beginning again.

In the options information inputting screen 32, as shown in FIG. 23, there are prepared fields for inputting a document finishing method (e.g., work code, number of documents, number of prints and document size) and a finish confirmation/delivery method. As the work code, it is possible to designate, for example, monochromatic printing or a CD-ROM. If the CD-ROM is designated, there is displayed a screen in which fields for inputting document size are omitted, as shown in FIG. 24.

When the user inputs these items and clicks a “Next” button 32A, it is decided at Step 214 that the input is ended. At Step 216, the input information is initially stored in the RAM 18BU, and the URL of a next screen responding to the “Next” button 32A is transmitted to the server 14.

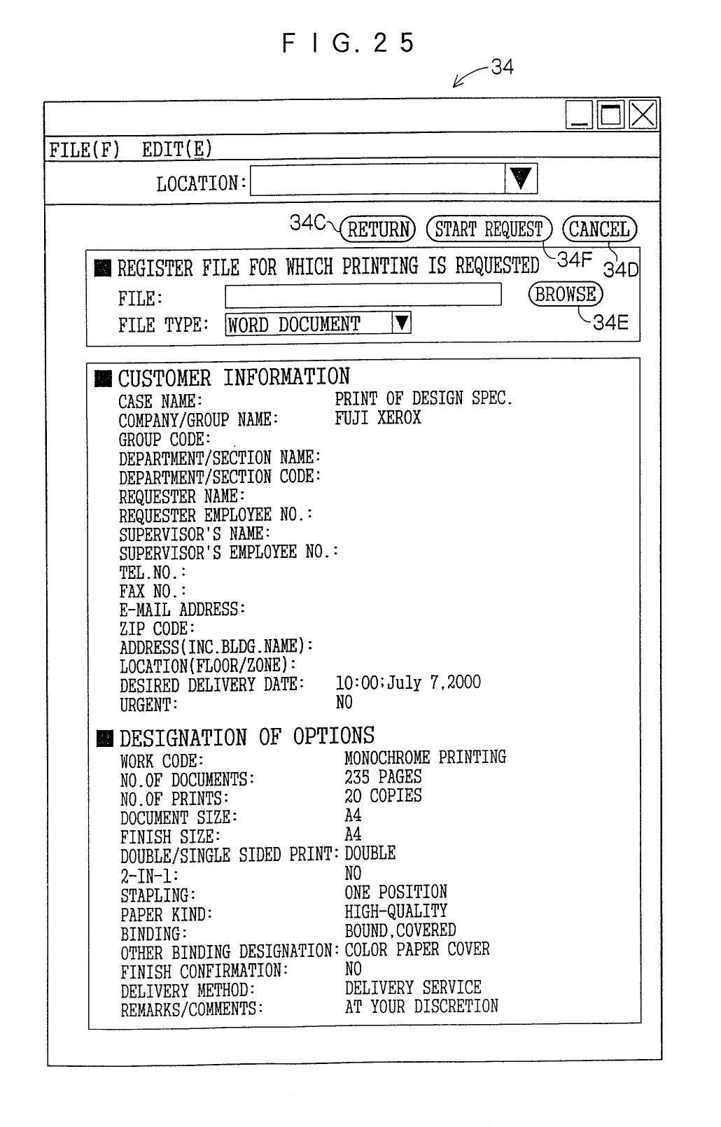

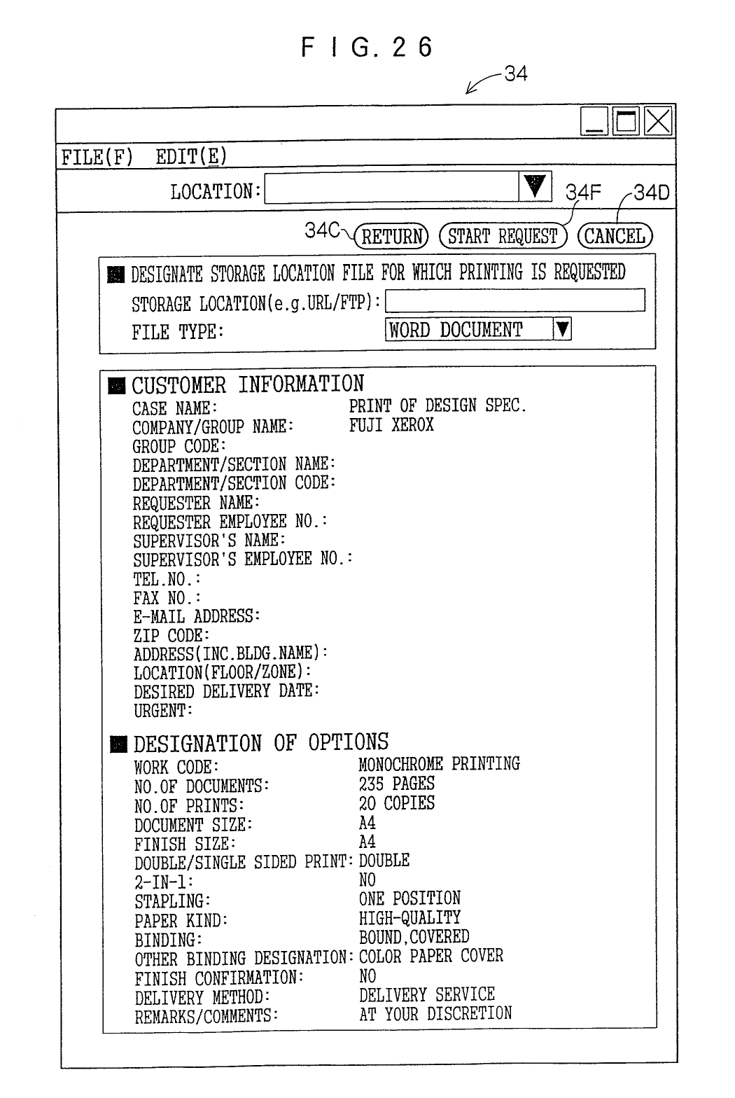

At the server 14, therefore, it is decided at Step 300 of FIG. 16A that the URL has been designated, and at Step 302 data of the designated URL is transmitted to the client 18U. At the client 18U, a file information inputting screen 34, as shown in FIG. 25 or FIG. 26, is displayed at Step 218.

If a “Return” button 32C is clicked, the result of step 220 is affirmative, and the routine returns to Step 202, i.e., to the customer information inputting screen 30. If a “Cancel” button 32D is clicked, the result of step 222 is affirmative and the present routine ends. If a “Reset” button 32B is clicked, the result of step 224 is affirmative, and the input details are reset at Step 226 so that the options information can be inputted from the beginning again.

As shown in FIG. 25 and FIG. 26, the file information inputting screen 34 is prepared for displaying the information which has been inputted in the customer information inputting screen 30 and the options information inputting screen 32, and the file name of the file for which printing is to be requested or the file storage location and a field for inputting file type. When the document kind has been designated to be electronically filed (or uploaded) in the customer information inputting screen 30, a file in a hard disk 18FU can be referred to and designated by pressing a “Browse” button 34E. On the other hand, when the document kind is URL/FTP, the storage location of the file is designated directly, as shown in FIG. 26.

When the user inputs these items and clicks a “Start Request” button 34F, it is decided at Step 228 that the input has been ended, and the input information such as the customer information, the options information and the file information are uploaded to the server 14 as upload data. When electronic filing is designated as the document kind in the customer information, the designated file is read and uploaded as the document data.

If a “Return” button 34C is clicked, on the other hand, the result of step 232 is affirmative, and the routine returns to Step 208, i.e., to the options information inputting screen 32. If a “Cancel” button 34D is clicked, the result of step 234 is affirmative, and the present routine is ended.

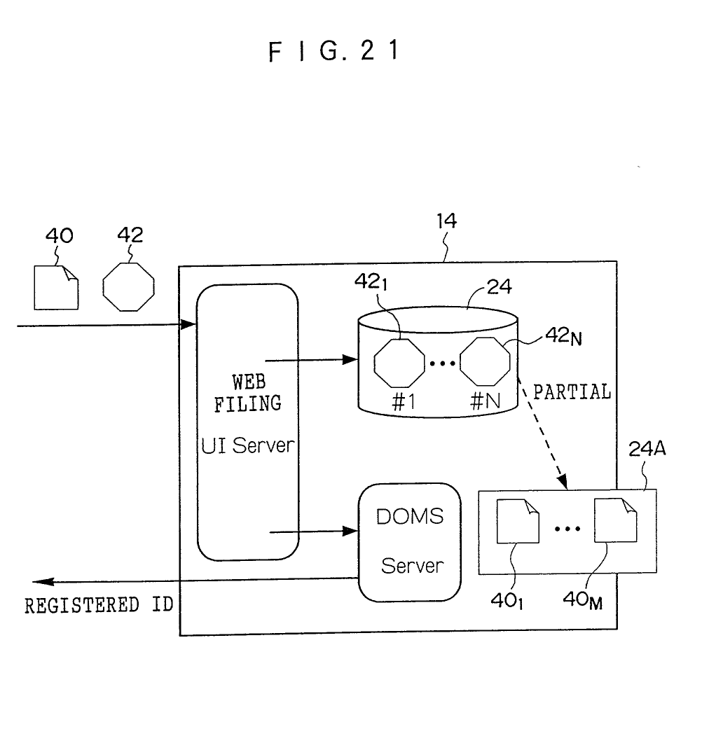

When it is decided at Step 304 of FIG. 16A that the upload data has been received, the server 14 sets a registration ID corresponding to the upload data at Step 306 and, at Step 308, stores the upload data together with the registration ID in the database 24. If URL/FTP is designated as the document kind in the customer information, the file is fetched from the storage location designated by the file information and is stored as the document data in the database 24. Thus, the document data, the customer information and the options information are stored together with the registration ID in the database 24, so that a reprint can be easily instructed later by designating the registered ID. Here, not all the document data needs to be stored in the database 24. If reprinting document data 40 and instruction data 42, such as the customer information and the options information, are uploaded to the server 14, as shown in FIG. 21, the instruction data 42 alone may be registered in the database 24, and a document data 40 portion for reprinting stored in a separately provided reprinting folder 24A.

At Step 310, the URL of a registration-completed screen informing of completion of registration is transmitted together with the registration ID to the client 18U.

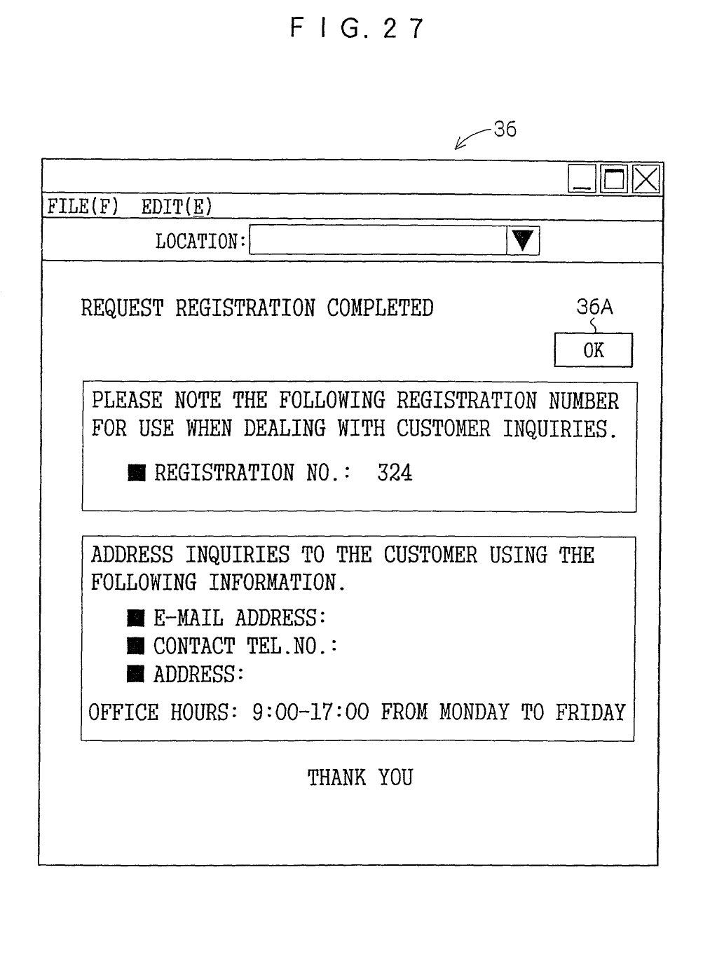

At the client 18U, it is decided at Step 236 of FIG. 15A and FIG. 15B that the URL of the registration-completed screen has been received, and at Step 238 a registration-completed screen 36, shown in FIG. 27, is displayed. If it is decided at Step 240 that an “OK” button 36A has been clicked, the present routine is ended.

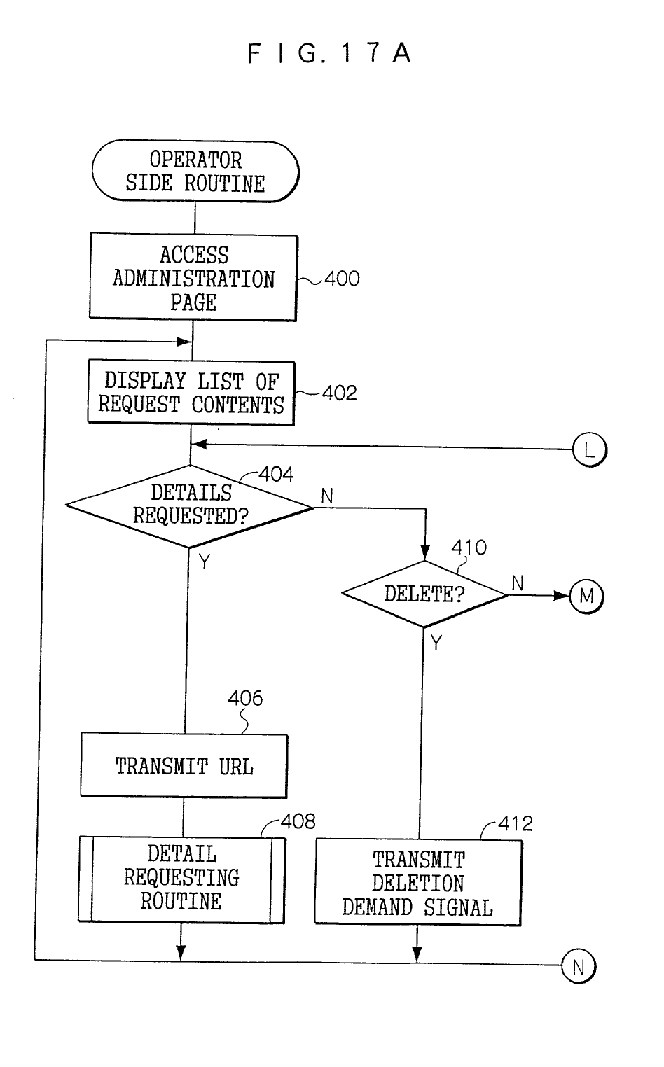

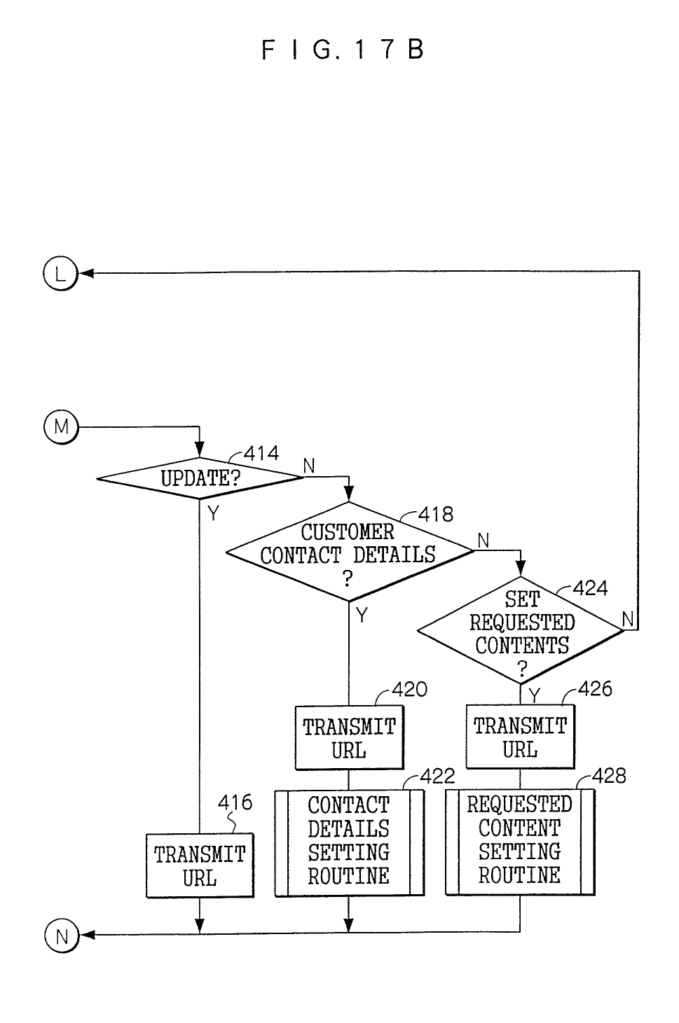

Now, the routine on the operator side will be described. At first Step 400, as shown in FIG. 17A, the operator controls the client 18O to access an administration page in the server 14, that is, to designate the URL of the administration page. At the server 14, it is decided at Step 300 of FIG. 16A that the URL of the administration page has been designated, and at step 302 the data of the designated URL is transmitted to the client 18O.

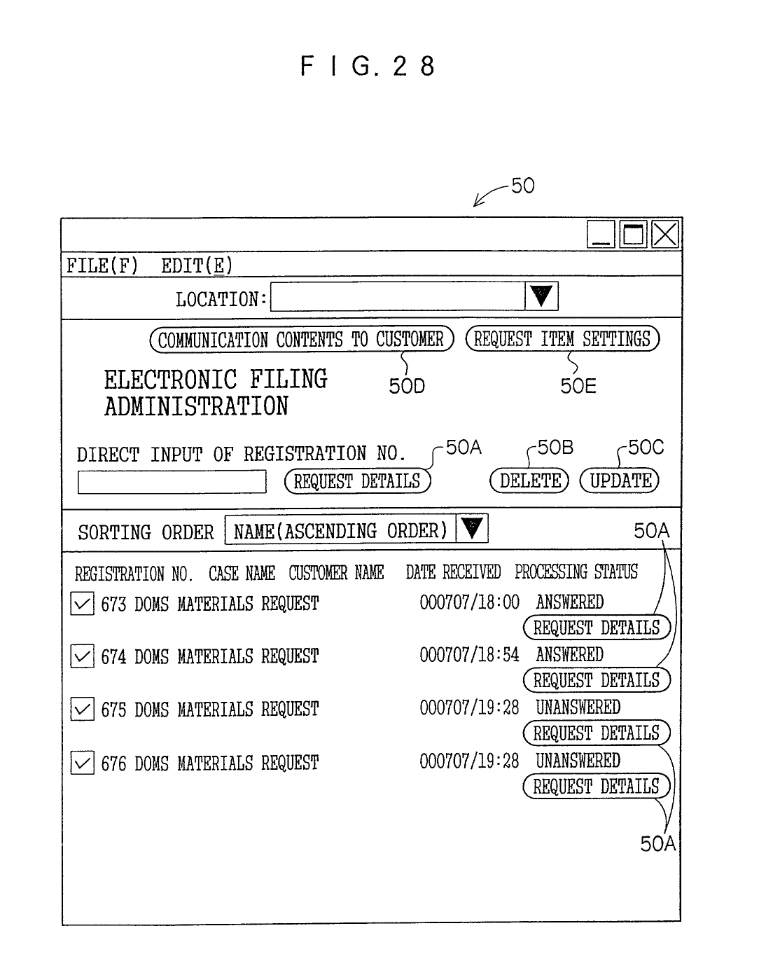

At the client 18O, at Step 402 of FIG. 17A, a requested content listing screen 50, as shown in FIG. 28, is displayed on the basis of the data transmitted from the server 14. More specifically, at Step 302 the server 14 transmits display data for displaying the requested content listing screen 50.

In the requested content listing screen 50, there are prepared fields for displaying a list of request details such as registration number (the registration ID), case name, customer name, date received and processing status, and for inputting the registration number. Here, the processing status may be: answered; unanswered; document awaited; being inquired; cancel; being delivered; and the like. By displaying the processing status thus, the operator is enabled to understand the processing status easily.

When the operator inputs a registration number directly or selects a registration number from the list display and clicks a “Request Details” button 50A, the result of step 404 is affirmative, and at Step 406 the URL of a next screen responding to the “Request Details” button 50A is transmitted to the server 14.

Accordingly, at the server 14, it is decided at Step 300 of FIG. 16A that a URL has been designated, and at step 302 the data of the designated URL is transmitted to the client 18O. At the client 18O, the details request is processed at Step 408.

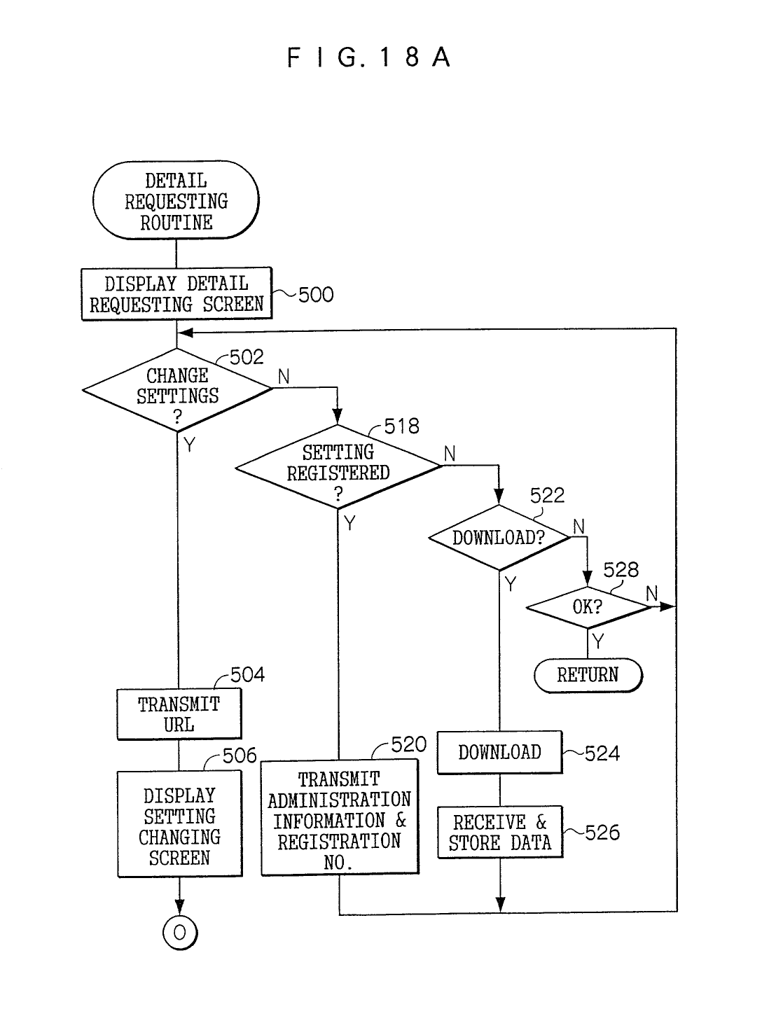

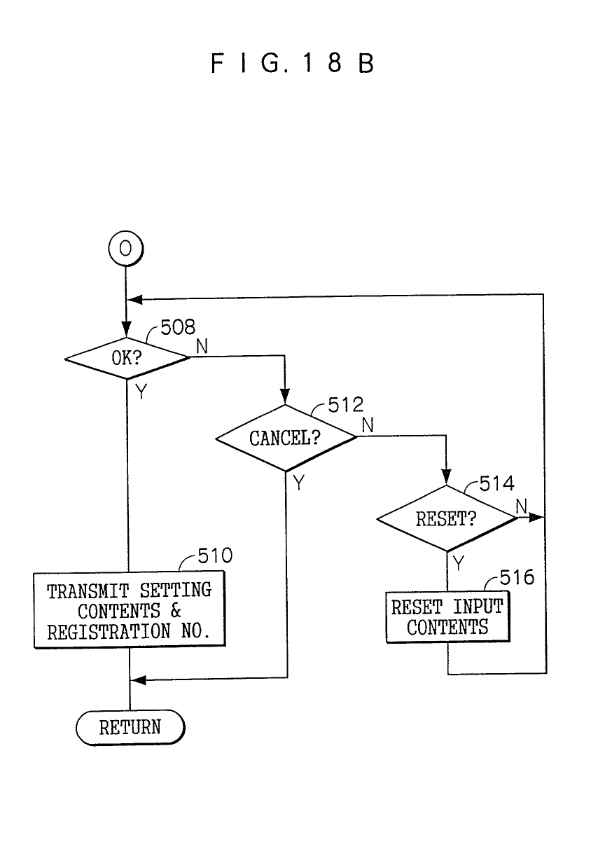

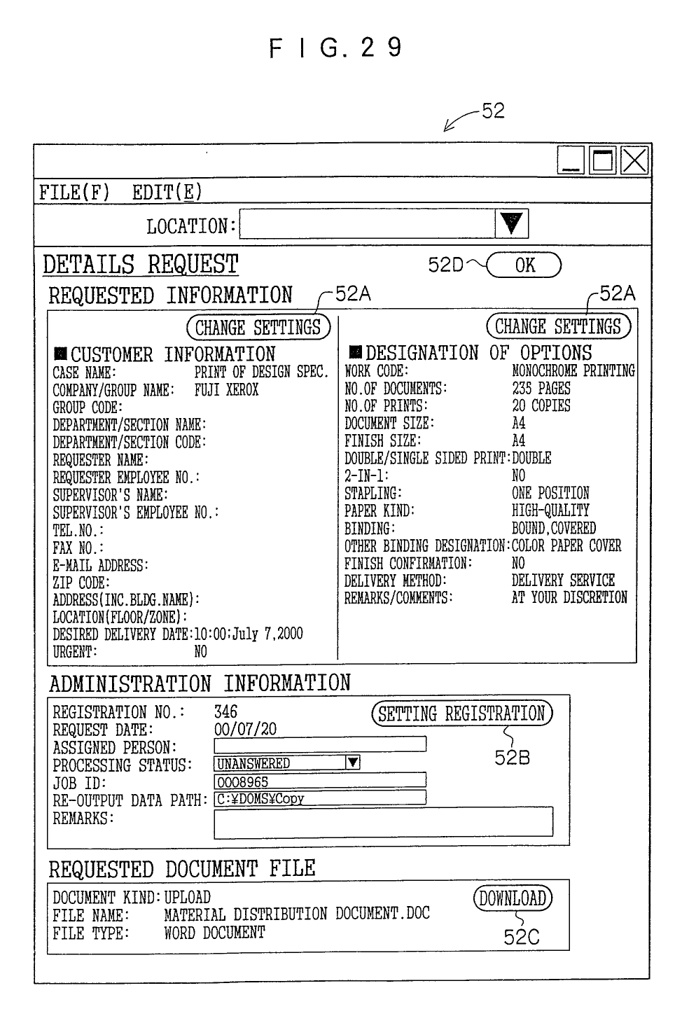

In a detail requesting routine, as shown in FIG. 18A and FIG. 18B, a detail requesting screen 52 shown in FIG. 29 is displayed at Step 500. At the detail requesting screen 52, as shown in FIG. 29, there are displayed the requested information (e.g., information of the customer and designation of options), administration information and information of the requested document file. The display area of the administration information is provided with fields for inputting an assigned person, processing status, job ID and a re-output data path. Thus, the job ID can be inputted so that unautomated post-treatment information (e.g., on binding or punching work by an operator) and other information such as the customer information can be linked even if separately stored.

When a “Change Settings” button 52A is clicked, at Step 504 the URL of a next screen responding to the “Change Settings” button 52A is transmitted to the server 14.

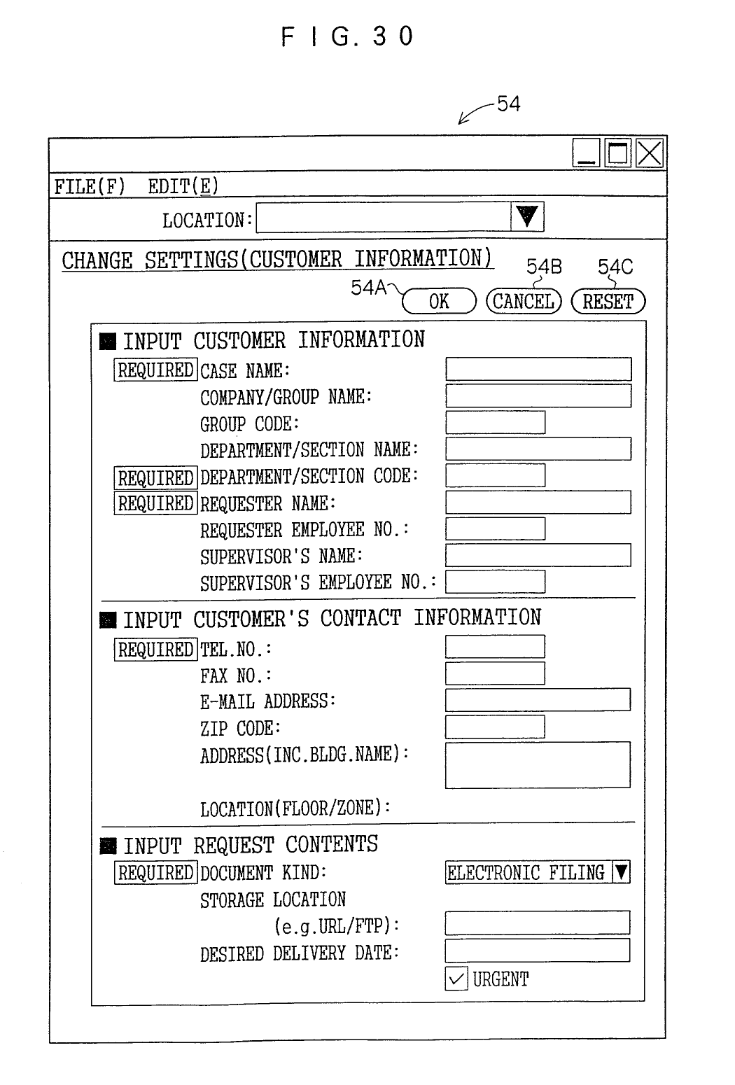

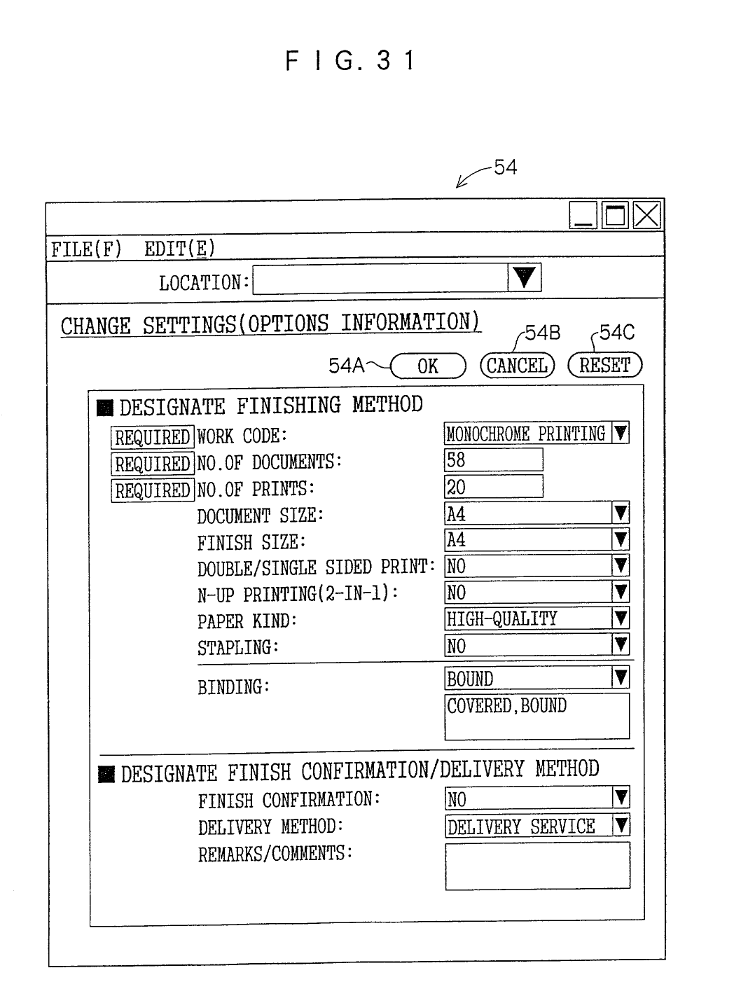

Accordingly, at the server 14, it is decided at Step 300 of FIG. 16A that a URL has been designated, and at step 302 the data of the designated URL is transmitted to the client 18O. At the client 18O, a setting changing screen 54, shown in FIG. 30 and FIG. 31, is displayed at Step 506. Here, the screen shown in FIG. 30 is displayed when change settings is selected for the customer information, and the screen shown in FIG. 31 is displayed when change settings is selected for the options information.

The setting changing screen 54 shown in FIG. 30 is substantially similar to the customer information inputting screen shown in FIG. 22, and the setting changing screen 54 shown in FIG. 31 is substantially similar to the options information inputting screen shown in FIG. 23, so descriptions thereof will be omitted. In short, the settings of the customer information and the options information can be changed on the operator side.

When an “OK” button 54A is clicked, it is decided at Step 508 that input has been ended, and at Step 510 setting contents and the registration number are transmitted to the server 14. Accordingly, at the server 14, it is decided at Step 312 of FIG. 16A that the setting contents have been received, and the setting contents are changed at Step 314. Specifically, the setting contents for which the customer information or options information corresponding to the designated registration number has been received, as stored in the database 24, are changed.

When a “Cancel” button 54B is clicked, on the other hand, the result of step 512 is affirmative, and the routine is returned. When a “Reset” button 54C is clicked, the result of step 514 is affirmative, and the input content is reset at Step 516 so that inputting can be restarted.

In the detail requesting screen 52 shown in FIG. 29, the operator can input the administration information such as the assigned person, the processing status and the job ID, and click a “Setting Registration” button 52B. In this case, the result of step 518 is affirmative, and at Step 520 the inputted administration information is transmitted to the server 14.

Accordingly, at the server 14, it is decided at Step 316 of FIG. 16B that the administration information has been received, and the received administration information is correlated to the corresponding registration number and stored in the database 24 at Step 318.

If, on the other hand, a “Download” button 52C is clicked, the result of step 522 is affirmative, and at Step 524 a download demand signal containing the file information of the file to be downloaded is transmitted to the server 14.

Accordingly, at the server 14, it is decided at Step 320 of FIG. 16B that the download demand signal has been received, and at Step 322 the designated file is downloaded and transmitted to the client 18O. At the client 18O, at Step 526 the data transmitted from the server 14 is received and stored in a hard disk 18FO or the like.

If the “OK” button is clicked, the result of step 528 is affirmative, and the routine is returned.

If the operator designates a registration number in the requested content listing screen 50 and clicks a “Delete” button 50B, the result of step 410 is affirmative, and at Step 412 a deletion demand signal containing the registration number designated to be deleted is transmitted to the server 14.

Accordingly, at the server 14, it is decided at Step 324 of FIG. 16B that the deletion demand signal has been received, and at Step 326 the data corresponding to the designated registration number is deleted from the database 24.

If an “Update” button 50C is clicked, the result of step 414 is affirmative, and the URL of the requested content listing screen is transmitted again at Step 416. Accordingly, at the server 14, it is decided at Step 300 of FIG. 16A that a URL has been designated, and at step 302 the data of the designated URL is transmitted to the client 18O. As a result, an updated requested content listing screen is displayed.

If a “Customer contact details” button 50D is clicked, the result of step 418 is affirmative, and the URL of a next screen responding to the “Customer contact details” button 50D is transmitted at Step 420.

Accordingly, at the server 14, it is decided at Step 300 of FIG. 16A that a URL has been designated, and at step 302 the data of the designated URL is transmitted to the client 18O. At the client 18O, a contact details setting routine is executed at Step 422.

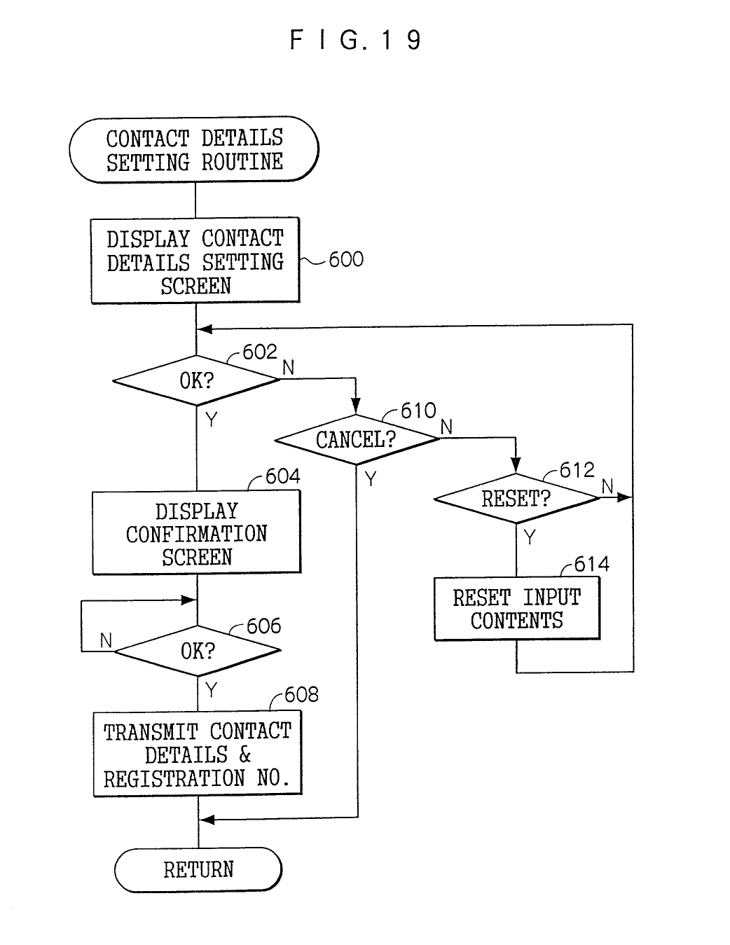

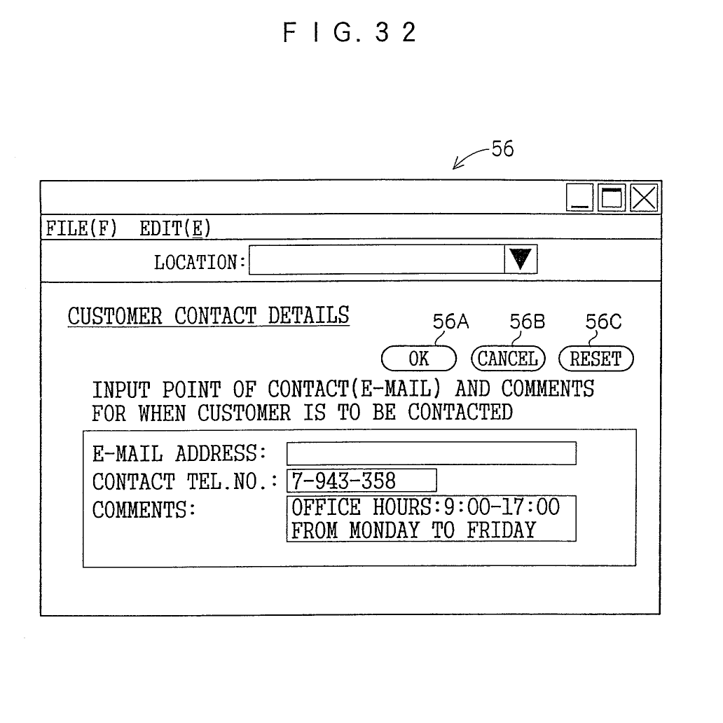

In the contact details setting routine, as shown in FIG. 19, at Step 600 a contact details setting screen 56, shown in FIG. 32, is displayed.

As shown in FIG. 32, the contact details setting screen 56 is a screen for inputting the content displayed in the registration-completed screen 36 shown in FIG. 27, and is provided with fields for inputting an e-mail address, contact telephone number and comments.

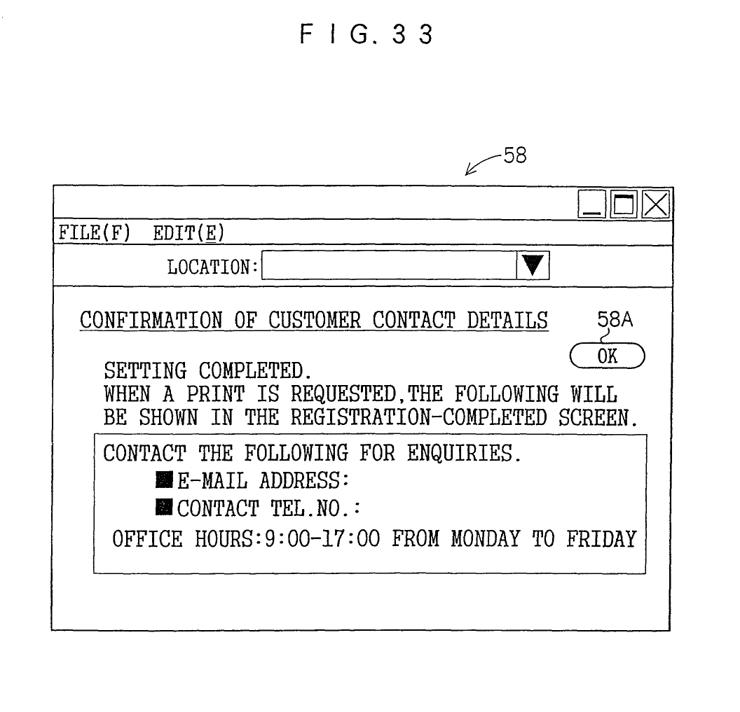

When the operator inputs these items and clicks an “OK” button 56A, it is decided at Step 602 that the inputting is ended, and at Step 604 a confirmation screen 58, shown in FIG. 33, is displayed. If the operator clicks an “OK” button 58A in the confirmation screen 58, the result of step 606 is affirmative, and at Step 608 the contact details and the inputted registration number are transmitted to the server 14. Accordingly, at the server 14, it is decided at Step 328 of FIG. 16B that the contact details have been received, and at Step 330 the contact details are correlated to the designated registration number and stored in the database 24.

If, on the other hand, a “Cancel” button 56B is clicked, the result of step 610 is affirmative, and the routine is returned. If a “Reset” button 56C is clicked, the result of step 612 is affirmative, and at Step 614 the input contents are reset so that inputting can be restarted.

When, in the requested content listing screen 50 shown in FIG. 28, the operator designates a registration number and clicks a “Requested Item Settings” button 50E, the result of step 424 is affirmative, and at Step 426 the URL of a next screen responding to the “Requested Item Settings” button 50E is transmitted to the server 14.

Accordingly, at the server 14, it is decided at Step 300 of FIG. 16A that a URL has been designated, and at step 302 the data of the designated URL is transmitted to the client 18O. In the client 18O, a request item settings routine is executed at Step 428.

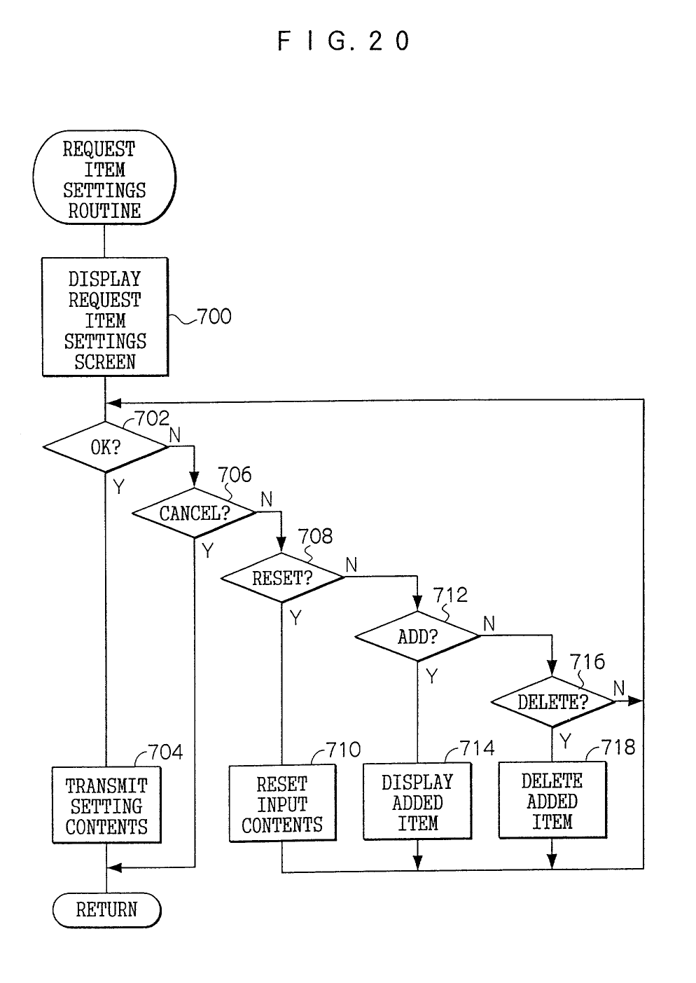

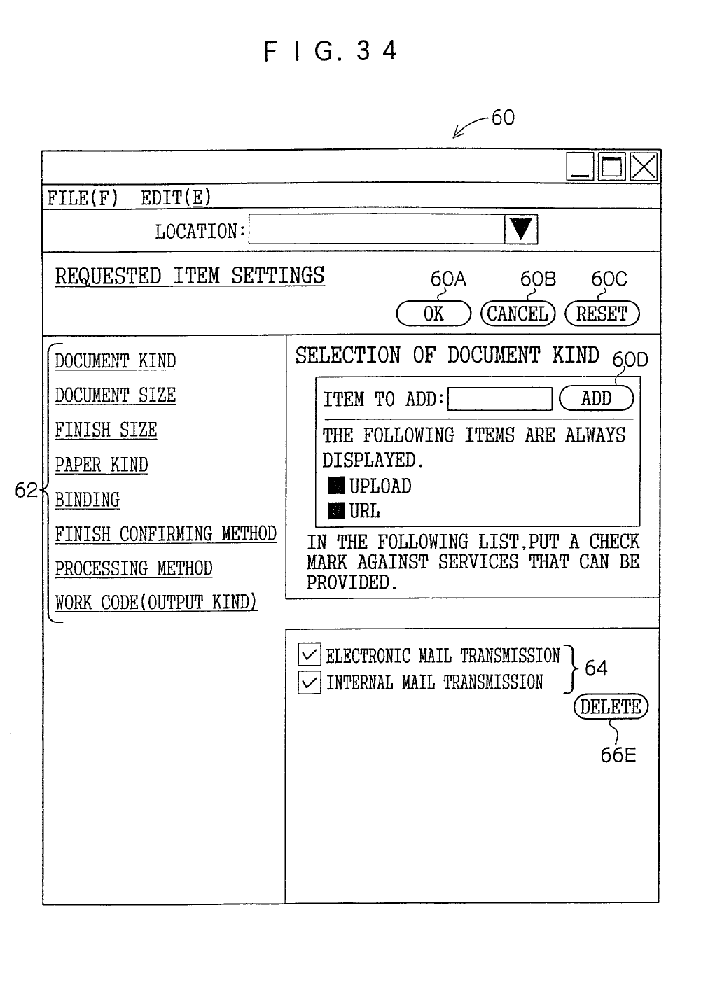

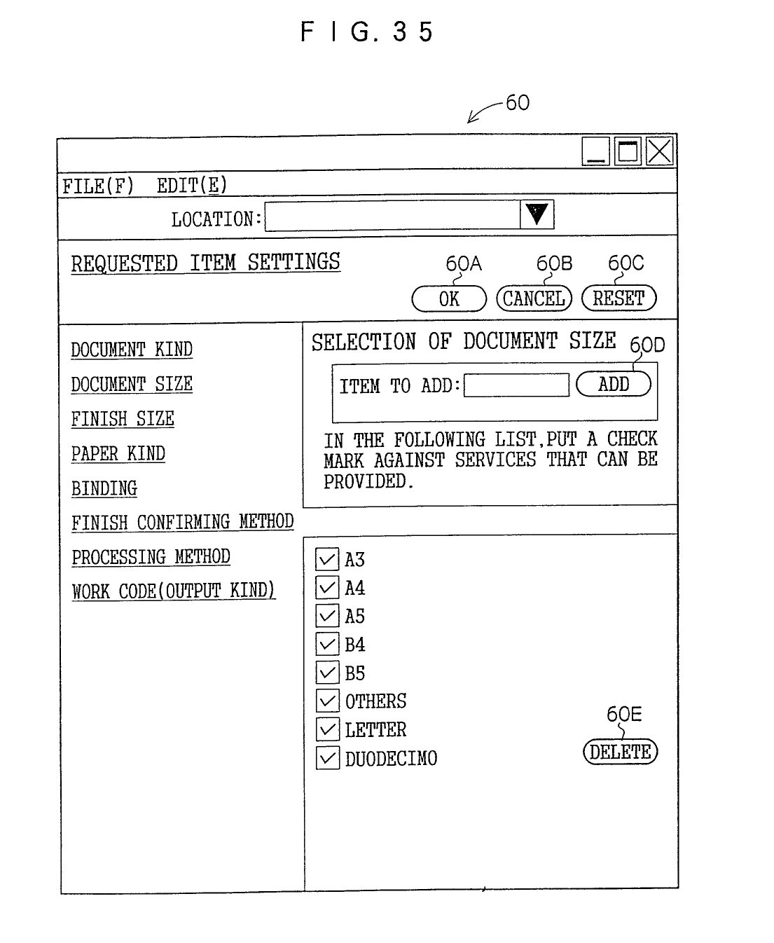

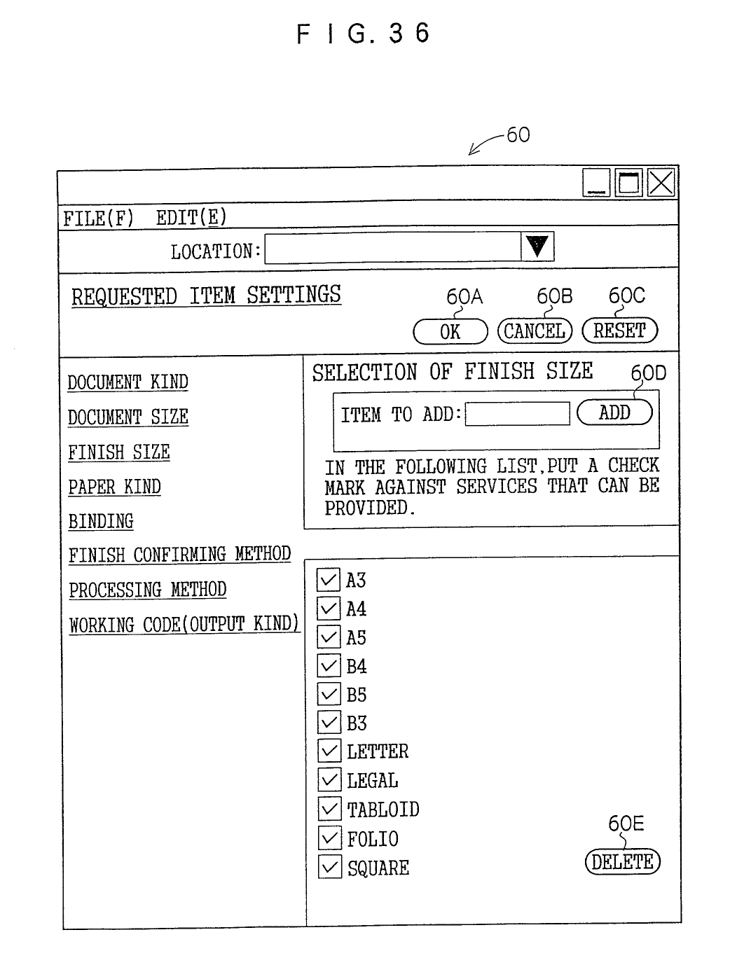

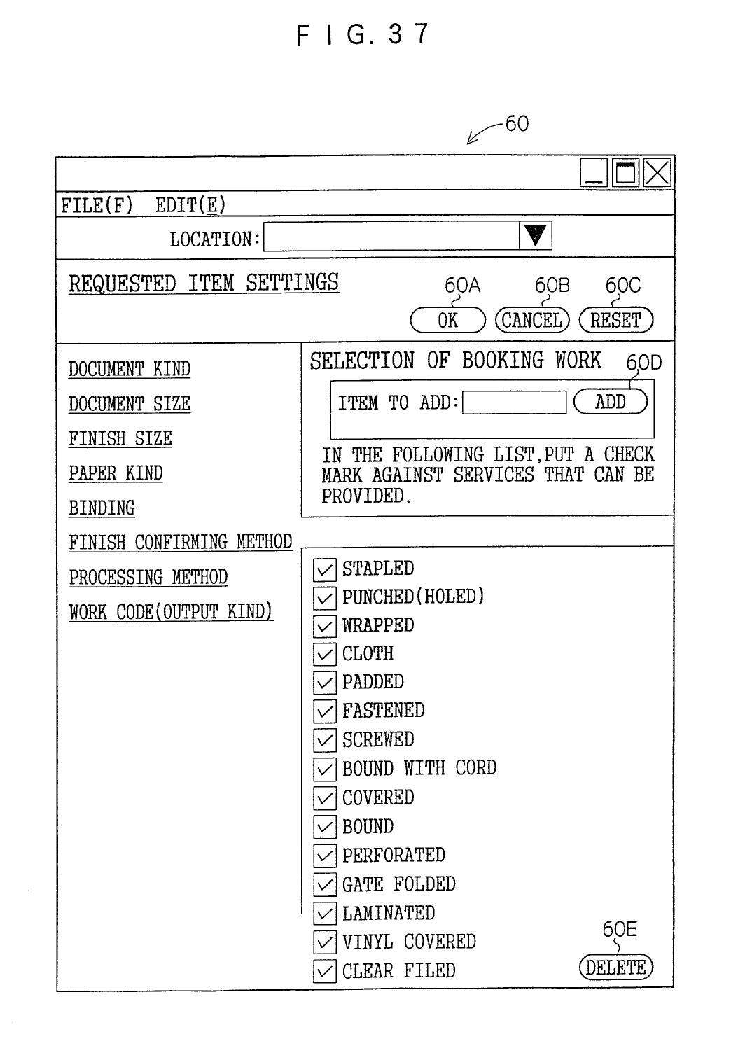

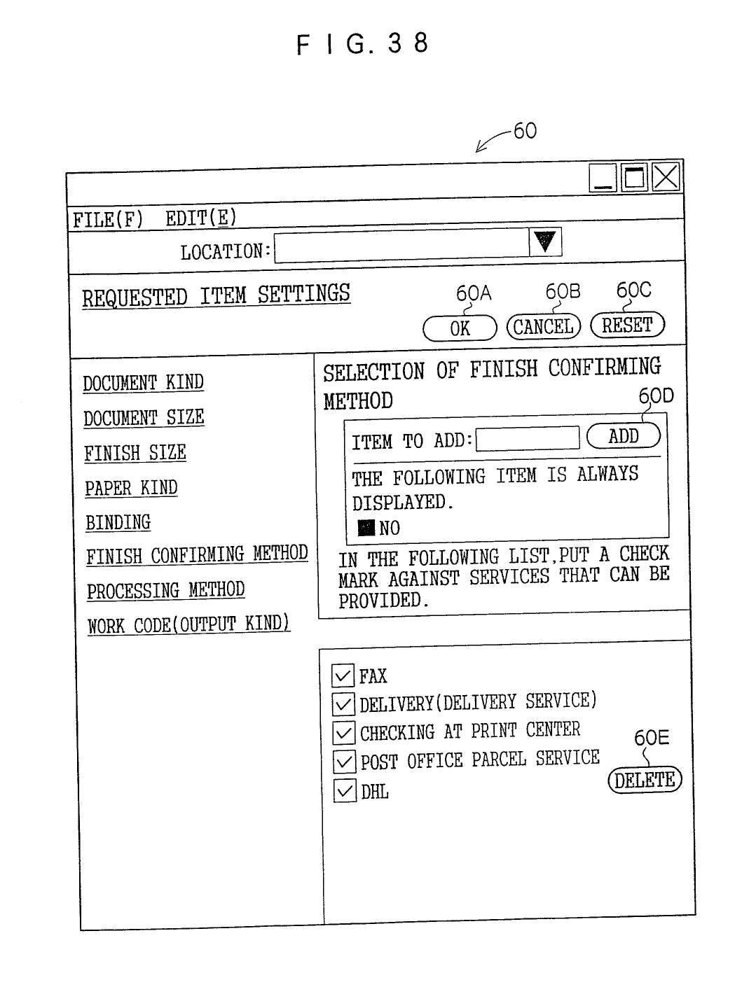

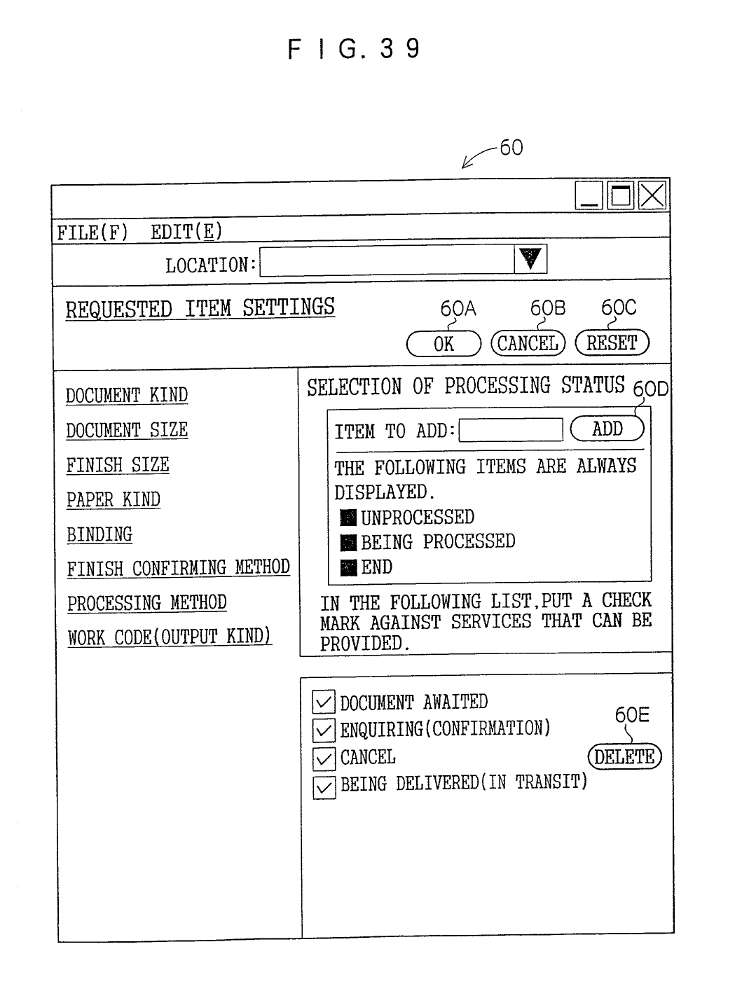

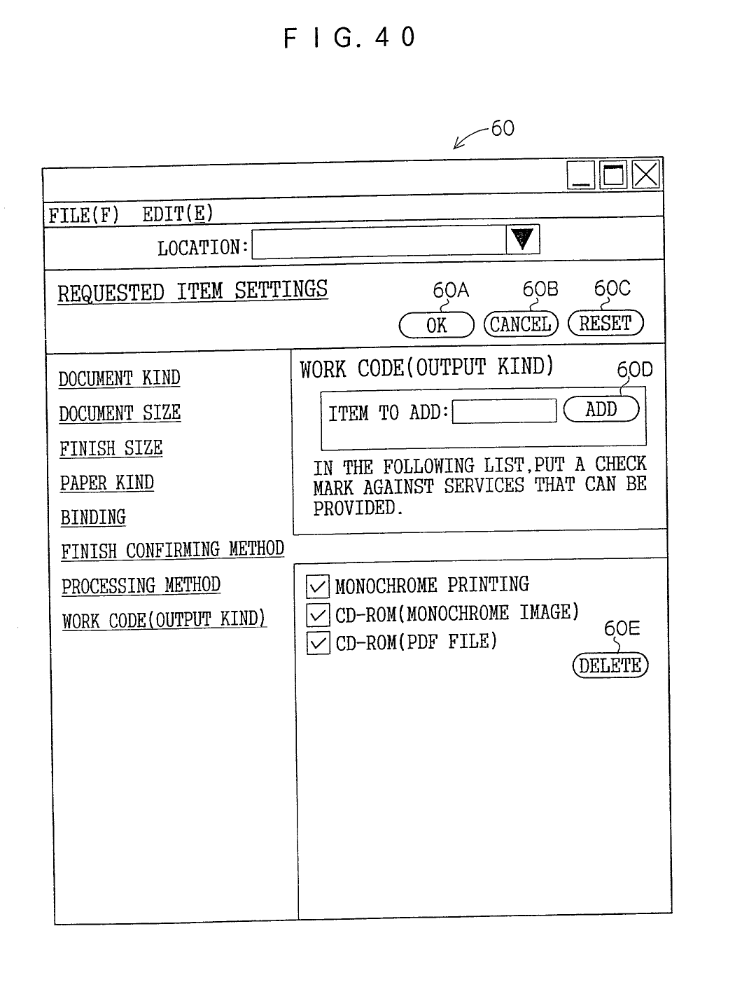

In the request item settings routine, as shown in FIG. 20, a request item settings screen 60, as shown in FIG. 34 through FIG. 40, is displayed at Step 700.

As shown in FIG. 34 through FIG. 40, the request item settings screen 60 is a screen for setting the contents to be displayed in the customer information inputting screen 30 and the options information inputting screen 32 shown in FIG. 22 and FIG. 23, and is provided with individual fields of additional items, for adding new choices such as document types and the like. Here, the screen is switched to one the request item settings screens shown in FIG. 34 through FIG. 40 by clicking one of the items in requested items 62, such as document kind, document size, finish size, paper kind, binding work, finish confirming method, processing method and work code (output kind).

When an “OK” button 60A is clicked, moreover, it is decided at Step 702 that the setting is ended, and the set contents inputted are transmitted at Step 704 to the server 14. Accordingly, at the server 14, it is decided at Step 332 of FIG. 16B that the set contents are received, and the set contents are stored at Step 334 in the database 24.

If a “Cancel” button 60B is clicked, the result of step 706 is affirmative, and the routine is returned. If a “Reset” button 60C is clicked, the result of step 708 is affirmative, and at Step 710 the input contents are reset so that inputting can be restarted.

When the operator inputs a new additional item and clicks an “Add” button 60D, the result of step 712 is affirmative, and at Step 714 an added item 64, inputted as shown in FIG. 34, is displayed. If, on the other hand, the operator designates the added item 64 and clicks a “Delete” button 60E, the result of step 716 is affirmative, and at Step 718 the designated added item 64 is deleted. Thus, requested items can be added by the control of the operator.

When the operator selects content requested by the user, i.e., selects a registration number from a not-shown control screen, designates a printer and instructs printing, the result of step 336 of FIG. 16B is affirmative at the server 14, and the document data and options information corresponding to the registration number are read and transmitted to the designated printer 16. As a result, the document of the designated contents is printed by the printer 16.

When a document filed in the server 14 is to be printed again, the user may access a not-shown reprinting page and may input the registration number that was designated at the document filing time. As a result, it is possible to make a reprint. Here, this reprinting routine may be performed manually by the operator or automatically by the server 14.

When the user thus files a document to be printed to the server, the document is designated by the registration number so that it can be easily reprinted without inputting various pieces of information.

In the above descriptions the document of the designated content is printed by the designated printer 16, but the present invention is not limited thereto. As described in the first and second embodiments, for example, the processing amount of the printing job and a predetermined value may be compared to select and print on one or more of the printers having different processing capacities on the basis of a comparison result.

Furthermore, the printing may be set either for a time period preset at the timer agent 14H or according to the loading condition of the network, as monitored by the communication control unit 14G. Moreover, when the processing amount of the printing job exceeds the predetermined value, the job may be divided into separate jobs of processing amounts less than the predetermined value, and the separate jobs may be individually transmitted to a plurality of the printers.

Here, the first to third embodiments have been described for the case in which the control screen is generated at the scanner on the basis of the transmitted text data or the like and displayed as the user interface in the display panel. However, the user interface can be disposed in the client or a multifunction machine so that the user interface can be controlled from the client or multifunction machine.

When the multifunction machine is connected with the print system of one of the first to third embodiments, for example, it normally acts as a single multifunction machine but can also act as a user interface device, an image input device or an image output device when a “network copy mode” is instructed.

Normally, the multifunction machine acts independently, displaying its intrinsic user interface screen in the display panel. When the multifunction machine is instructed to shift into the “network copy mode”, it issues a demand through the network to the server for acquiring information for generating a user interface screen, and, on the basis of information transmitted from the server, displays in its display panel a user interface screen capable of instructing setting/outputting types for another device connected to the network. Selection of an output destination printer and setting of the outputting type are performed from that screen, to instruct the start of network copying. When the document is then read out of the image reading unit of the multifunction machine, the read image and the information on the destination printer and the output form can be transmitted to the server and can be printed.

Further, in the first to third embodiments, output parameters are set at first so as to control an ordinary copying machine, and the routine from reading to printing of a document is performed automatically merely by pushing the start button. After the image has been read from the scanner by a scanning service and stored, however, the stored image can be outputted for printing by instructing reprinting, as will be described below.

When the image recorded in the document is to be stored, the scanning service is selected in the menu screen, and the document is set in the scanner unit 12A. Then the start button is pushed. As a result, it is decided that image reading has been instructed, and the scanner unit 12A is controlled so that the image recorded in the document is read. This read image data is stored as electronic image data in the memory 12D of the scanner. If a printer having a color outputting function (color printer) and a printer having a monochromatic outputting function (monochrome printer) are connected, the image is preferably read so as to obtain to obtain image data to be used in the printer having higher functionality, the color printer. If a high-resolution printer and a low-resolution printer are connected, the image is preferably read so as to obtain image data for the high-resolution printer.

If image data is inputted from an external storage device having the image data stored in advance, the aforementioned image reading routine is not necessary, but the image data read from the external storage device by using a not-shown reading device may be stored as common image data in the memory 12D by a single control.

When the image stored by the scanning service is then printed, a reprint service is selected in the menu screen. In the reprint service, a desired print can be reproduced from the images stored in the memory 12D of the scanner by performing a routine similar to the aforementioned print instructing routine.

Furthermore, the first to third embodiments have been structured such that the image read from the scanner is temporarily stored in the memory 12D of the scanner 12 and is transmitted from the memory 12D to the server 14 so that it maybe transmitted to the printer 16. However, at the document reading time, the read image may instead be transmitted to and stored in the server 14 for transmission to the printer 16. Alternatively, the image read by the scanner may be temporarily stored in the memory 12D of the scanner and transmitted directly to the printer without passing through the server 14.

Alternatively, the image read by the scanning service may be temporarily stored in the memory 12D of the scanner 12, and information indicating the storage location of the image may be transmitted to the server 14 or the printer 16, so that the server 14 or the printer 16 may read the image when the image is to be outputted from the printer 16 on the basis of the information indicating the storage location of the image.

In addition, the present invention has been described for the case in which the image is outputted to the printer, but the image can also be outputted to a multifunction machine or a facsimile device. The image may also be outputted as an electronic mail to another device (e.g., a mobile telephone) connected through the network.

According to the present invention, as described above, jobs such as copy jobs can be efficiently distributed and processed.

Another effect of the present invention is to enable the efficient processing of output.

What is claimed is:

1. An image administrating apparatus comprising:
an image inputting device connected to a network;
a plurality of image output devices connected to said network and having different processing capacities from one another; and
a controller that performs comparison of a processing amount of a printing job of image data inputted by said image inputting device with a predetermined processing amount, selects at least one of said image output devices in accordance with a result of said comparison, and transmits said printing job through said network to said at least one of said image output devices.

2. The image administrating apparatus of claim 1, wherein said controller transmits said printing job at a preset time period.

3. The image administrating apparatus of claim 1, wherein said controller transmits said printing job in accordance with load condition of said network.

4. The image administrating apparatus of claim 1, wherein, if said processing amount of said printing job exceeds said predetermined processing amount, said controller divides said printing job into separate jobs having processing amounts of no more than said predetermined amount, and transmits said separate jobs to at least two of said image output devices.

5. A distributed processing system comprising:
a first system including:
an output device connected to a network and capable of outputting an image on the basis of information on image data and on image data output form; and
a first administration device connected to said network which transmits said information, which is acquired through said network, to said output device; and
a second system connected with said first system through said network and including:
an image inputting device which includes
an image input device for inputting image data,
an information input device for inputting a transmission time at which said information is to be transmitted, and
a transmitter connected to said network for transmitting said image data inputted from said image input device and said information, which is inputted from said information input device, through said network, and
a second administration device connected to said network which holds said information which is transmitted from said image inputting device and, at said transmission time, transmits said information through said network to said first administration device.

6. A distributed processing system comprising:
a first system including:
a first image outputting device connected to a network and capable of outputting an image on the basis of information on image data and on image data output form; and
a first administration device connected to said network and capable of transmitting said information on image data and image data output form, which is acquired from said network, to said first image outputting device; and
a second system connected with said first system through said network and including:
a second image outputting device having processing capacity different from processing capacity of said first image outputting device, connected to said network, and capable of outputting an image on the basis of said information,
an image inputting device which includes
an image input device for inputting image data,
an information input device for inputting information on said image data output form, and
a transmitter connected to said network for transmitting said image data inputted from said image input device and said information on said image data output form inputted from said information input device through said network, and
a second administration device connected to said network, which, in accordance with a processing amount based on said information on image data and image data output form transmitted from said image inputting device, transmits said information on image data and image data output form through said network to at least one of said first administration device and said second image outputting device.

7. An administration apparatus connected through a network to a first client, a second client and an output device, the apparatus comprising:
a first generator which generates filing screen data and outputs said generated filing screen data to said first client, for display of a filing screen at said first client, to enable filing of document information relating to a document;
a second generator which generates administration screen data and outputs said generated administration screen data to said second client, for display of an administration screen at said second client, to enable administration of said document information; and
a controller which receives through said network said document information, which is inputted at said filing screen displayed at said first client, outputs said document information to said administration screen displayed at said second client, and on the basis of input information which is inputted at said administration screen, outputs said document information to said output device.

8. The administration apparatus of claim 7, wherein said output device comprises a plurality of output devices, one of said plurality of output devices having a different processing capacity from another thereof, and wherein said controller performs comparison of a processing amount of a printing job of said document with a predetermined threshold value, selects at least one of said plurality of output devices on the basis of a result of said comparison, and transmits said printing job through said network to said at least one of said plurality of output devices.

9. The administration apparatus of claim 8, wherein said controller transmits said printing job at a preset time period.

10. The administration apparatus of claim 8, wherein said controller transmits said printing job in accordance with load condition of said network.

11. The administration apparatus of claim 8, wherein, if said processing amount of said printing job exceeds said predetermined processing amount, said controller divides said printing job into separate jobs having processing amounts of no more than said predetermined amount, and transmits said separate jobs to at least two of said plurality of image output devices.

12. An electronic filing method comprising the steps of:
generating filing screen data and outputting said generated filing screen data to a first client, for displaying a filing screen at said first client, to enable filing of document information relating to a document;
generating administration screen data and outputting said generated administration screen data to a second client, for displaying an administration screen at said second client, to enable administration of said document information;
receiving through said network said document information inputted at said filing screen displayed at said first client and displaying said received document information at said administration screen displayed at said second client; and
on the basis of input information which is inputted through said administration screen, outputting said document to an output device connected to said network.

13. The electronic filing method of claim 12, wherein said output device comprises a plurality of output devices, one of said plurality of output devices having a different processing capacity from another thereof, and wherein said step of outputting said document comprises the substeps of: performing comparison of a processing amount of a printing job of said document with a predetermined processing amount; selecting at least one of said plurality of output devices on the basis of a result of said comparison; and transmitting said printing job through said network to said at least one of said plurality of output devices.

14. The electronic filing method of claim 13, wherein said step of outputting said document comprises the substep of transmitting said printing job at a preset time period.

15. The electronic filing method of claim 13, wherein said step of outputting said document comprises the substep of transmitting said printing job in accordance with load condition of said network.

16. The electronic filing method of claim 13, wherein, if said processing amount of said printing job exceeds said predetermined processing amount, said step of outputting said document comprises the substeps of: dividing said printing job into separate jobs having processing amounts of no more than said predetermined processing amount; and transmitting said separate jobs to at least two of said plurality of image output devices.

17. A computer-readable recording medium recorded with an electronic filing program for causing a computer for administering said electronic filing to execute:
generating filing screen data and outputting said generated filing screen data to a first client, for displaying a filing screen at said first client, to enable filing of document information relating to a document;
generating administration screen data and outputting said generated administration screen data to a second client, for displaying an administration screen at said second client to enable administration of said document information;
receiving through said network said document information inputted at said filing screen displayed at said first client and displaying said received document information at said administration screen displayed at said second client; and
on the basis of input information which is inputted through said administration screen, outputting said document to an output device connected to said network.

18. An electronic filing system comprising:
a document data storage connected to a network, which stores document data;
an output device connected to said network and capable of outputting a document on the basis of information on document data and document options;
a control device including
a display input device which displays a control screen generated on the basis of signals for generating said control screen, for input to said displayed control screen of control information including user information, information for designating said document data, and information on said document options, and
a transmitter connected to said network, which transmits said control information through said network and acquires said signals for generating said control screen through said network;
an administration control device including
an administration display input device which displays an administration control screen generated on the basis of signals for generating said administration control screen, for input of information for designating said control information inputted to said display input device, which information for designating said control information is stored at said document data storage, and for input of information for designating said output device to output said document data, and
an administration transmitter connected to said network, which acquires said signals for generating said administrating control screen through said network; and an administration device including
a communication unit connected to said network, which fetches said document data that is designated by said information for designating said document data, which information is transmitted from said control screen, generates said signals for generating said control screen and transmits said signals to said control device, generates said signals for generating said administration control screen and transmits said signals to said administration control device, and transmits said information on document data and document options of said designated document data through said network to said designated output device, and
a storage which stores said fetched document data, and stores said user information and said information on said document options which are transmitted from said control device.

19. The electronic filing system of claim 18, wherein, when said administration device receives said control information which is transmitted from said control device, said administration device transmits a registration ID to said control device and stores said control information in said storage in correspondence with said registration ID.
